(19) United States
(12) Patent Application Publication
(10) Pub. No.: US 2025/0137274 A1
(43) Pub. Date: May 1, 2025

(54) Information System for a Robotic Parking Garage

(71) Applicant: Robotic Technology Administration, LLC, Clearwater, FL (US)

(72) Inventors: Royce Monteverdi, Clearwater, FL (US); Rajeev Aswal, Clearwater, FL (US); Ramanathan Ramasubbu, Clearwater, FL (US)

(21) Appl. No.: 18/496,622

(22) Filed: Oct. 27, 2023

(51) Int. Cl. E04H 6/42

(52) U.S. Cl. CPC E04H 6/424

(57) ABSTRACT

Disclosed herein is a user interface for an automated parking garage that is coupled to a controller. The controller is coupled with a machine associated with the operation of an automated, or robotic, parking garage and a sensor operable to obtain data from the machine. In an example embodiment, the user interface displays a runtime value and a threshold value corresponding to the runtime value. The user interface is operable to receive a change to the threshold value via the input. In an example embodiment, the user interface comprises diagnostic screens corresponding to machines that are operating in the automated parking garage. Status data for a machine to displayed on its corresponding diagnostic screen and in response to receiving an input, the controller causes the machine, or one or more of its components, to move a predefined distance or to a predefined position when operating in a certain modes.

### TECHNICAL FIELD

The present disclosure relates generally to runtime control, tracking, and diagnostics of machines employed in robotic parking garages.

### BACKGROUND

Robotic parking garages have been around since the late 1950s. Early automated parking garages utilized crane systems, conveyors, hydraulics, and pneumatics for transporting vehicles for storage and retrieval. More recently, automated parking garages have employed more advanced systems that include computer-controlled, specialized equipment for storing and retrieving systems. However, these systems have rudimentary user interfaces for monitoring and controlling the equipment.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus comprising a machine associated with an operation of an automated parking garage that comprises a motor, a controller coupled with the machine and operable to control and monitor operation of the motor, and a sensor coupled with the motor and the controller, and a user interface coupled with the controller that comprises a display and an input. The sensor is operable to obtain data representative of a movement of the motor and provide the data representative of the movement of the motor to the controller. The user interface displays a runtime value for the machine. A threshold value corresponding to the runtime value is displayed on the user interface. The user interface is operable to receive a change to the threshold value via the input.

In accordance with an example embodiment, there is disclosed herein a user interface that comprises diagnostic display screens corresponding to machines for operating an automated, or robotic, parking garage. The user interface is coupled with a controller that is coupled with the machines. The diagnostic display screens comprise an input that are operable to control the operation of the corresponding machines. The controller is operable to cause status data for the machine to be displayed on a corresponding diagnostic screen and responsive to receiving an input when the machine is in certain modes from the corresponding diagnostic screen to move the machine an amount specified in the input.

### BRIEF DESCRIPTION OF THE DRAWINGS

The accompanying drawings incorporated herein and forming a part of the specification illustrate the example embodiments.

FIG. 1 is a cutaway view illustrating the interior of an automated parking garage upon which an example embodiment is implemented.

FIG. 2 is a block diagram illustrating an example of a plurality of automated parking garage modules that further comprise additional entry level carriers and terminals where multiple items can be moved at the same time and an example embodiment is implemented.

FIG. 3 is a block diagram illustrating an example of a system for operating an automated parking garage in accordance with an example embodiment.

FIG. 4 is a block diagram illustrating an example of a system employed by a robotic parking garage that comprises a controller for controlling a machine associated with the robotic parking garage and a user interface allowing an operator to obtain real time data about the machine and interact with the controller to control operation of the machine.

FIG. 5 illustrates an example of a first user interface screen for providing runtime data and providing inputs for maintaining a first plurality of robotic parking garage machines.

FIG. 6 illustrates an example of a second user interface screen for providing runtime data and providing inputs for maintaining a second plurality of robotic parking garage machines.

FIG. 7 illustrates an example of a third user interface screen for providing runtime data and providing inputs for maintaining a third plurality of robotic parking garage machines.

FIG. 8 illustrates an example diagnostic screen for an Entry Exit Station (EES).

FIG. 9 illustrates an example diagnostic screen for a first floor Carrier Module with Turn Table (CM TT).

FIG. 10 illustrates an example diagnostic screen for a Rack Entry Module (REM).

FIG. 11 illustrates an example diagnostic screen for an upper-floor Carrier Module. (UCM)

FIG. 12 illustrates an example diagnostic screen for a Vertical Lift Conveyer. (VLC)

FIG. 13 illustrates an example diagnostic screen for a Pallet Shuttle. (PS)

FIG. 14 illustrates an example diagnostic screen for a Pallet Stacker. (PST)

FIG. 15 illustrates an example diagnostic screen for a Pallet Vertical Lift. (PVL)

FIG. 16 illustrates an example of an operator interface to view the status of vehicles that were parked in the parking garage.

FIG. 17 is a block diagram that illustrates a computer system upon which an example embodiment may be implemented.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

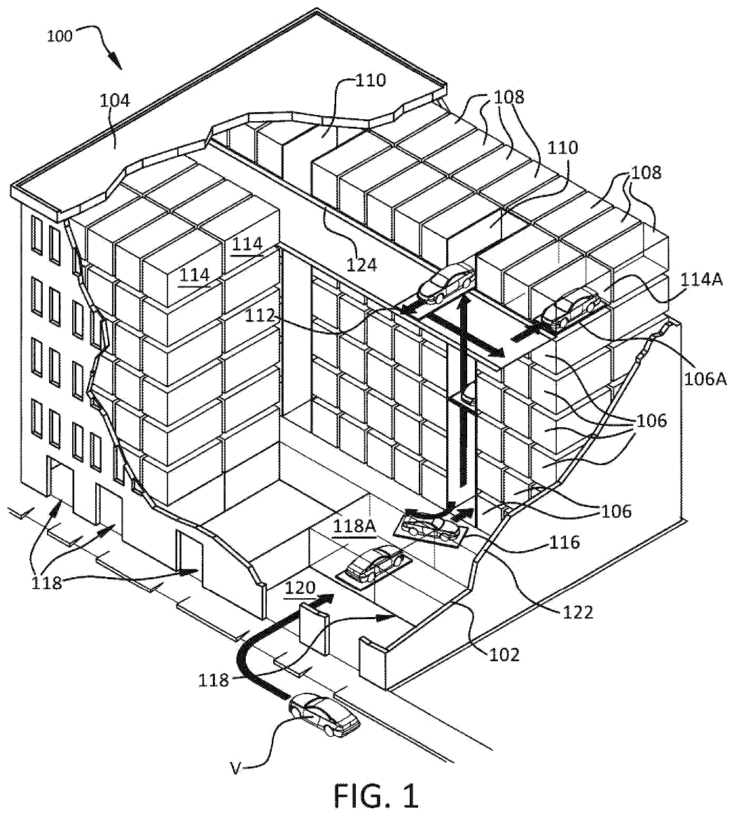

FIG. 1 is a cutaway view illustrating the interior of an automated parking garage 100 upon which an example embodiment is implemented. In the illustrated example, portions of the exterior wall 102 and roof 104 are removed in order to view the interior of the automated parking garage 100.

In the illustrated example, the automated parking garage 100 comprises a plurality of levels (or floors) 106 and a plurality of vertical storage units 108 (which are used for parking vehicles but can also be used to store storage containers, thus storage units 108 may also be referred to herein as “parking spaces” or “storage spaces” on the plurality of levels 106. The automated parking garage 100 further comprises a vertical lift carrier (“VLC”) 110, upper horizontal carriers (“UCM”) 112, and entry level carrier (“EES”) 116, and a plurality of entry exit stations (also referred to herein as “terminals”) 118. In the illustrated example, the storage (or parking) units 108 have two storage spaces 114 that can be parking space configured to parking cars and/or storing containers. Thus, storage space 114 may also be referred to as a parking space.

The entry level carrier 116 transports a vehicle along the entry level of the automated parking garage 100. For example, the ELC 116 can transport vehicle V from an entry/exit station 118 to a vertical lift carrier 110 and/or to storage units 108 on the entry level. The vertical lift carrier 110 transports the vehicle V between floors and the upper horizontal carrier 112 transports the vehicle V along a floor, such as for example to or from a VLC 110 and a storage unit 108.

In an example embodiment, the parking garage 100 has storage spaces 114 on both sides of the aisle 122 as illustrated in FIG. 1. Those skilled in the art can readily appreciate that in other embodiments there may be vertical storage units 108 located on one side of the aisle 122.

In the illustrated example, the vertical storage unit 108 has two storage spaces 114 per level 106. As those skilled in the art can readily appreciate, other embodiments may have a single storage space 114 or any other physically realizable number of storage spaces.

In operation, when a vehicle V enters an entry exit station 118A, the vehicle V drives onto a pallet 120. In an example embodiment, the pallet is made of steel, however, those skilled in the art can readily appreciate that any suitable material can be employed for pallet 120. The pallet 120 with vehicle V thereon are transferred to entry level carrier 116 located in aisle 122.

In an example embodiment, the entry level carrier 116 is rotated one hundred and eighty degrees. Thus, when the vehicle V is later retrieved for departure, it is facing the entrance of a terminal 118 obviating the need for the driver to back out of the garage 100. In the illustrated example, the vehicle V is being parked on a different level than the terminal 118A. The vehicle is transferred to a vertical lift carrier 110 for transport to the appropriate level. Once at the appropriate level 106 106A in this example, the vehicle V is transferred to an upper horizontal carrier 112. The upper horizontal carrier 112 is motorized and is operable to travel horizontally via rail 124. The upper horizontal carrier 112 transports the vehicle V adjacent to storage (parking) space 114A, and the vehicle is transferred into storage (parking) space 114A.

As those skilled in the art can readily appreciate, the number of levels 106, vertical storage units 108, vertical lift carriers 110, upper horizontal carriers 112 parking spaces 114, entry level carriers 116, and terminals 118 were merely selected for ease of illustration, and that the principles described herein can be applied to automated parking garages having any desired, physically realizable number of levels 106, vertical storage units 108, vertical lift carriers 110, upper horizontal carriers 112 parking spaces 114, entry level carriers 116, and terminals 118. Thus, the example embodiments described herein should not be construed as being limited to the configuration of the automated parking garage 100 illustrated in FIG. 1.

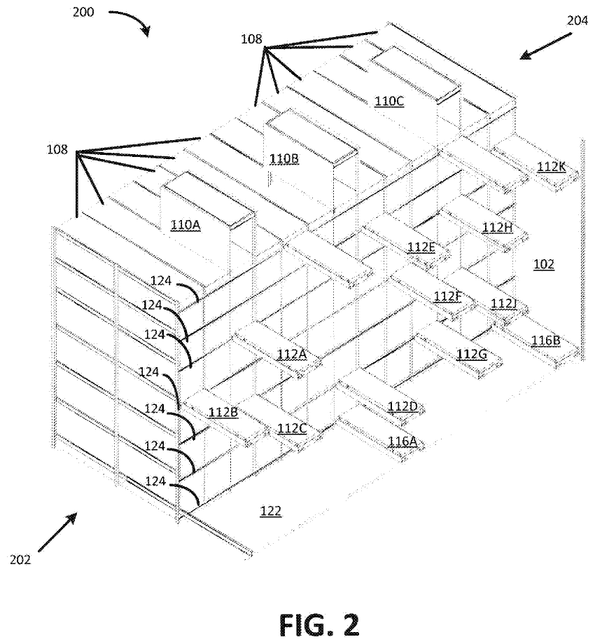

FIG. 2 is a block diagram illustrating a second example of a section 200 of an automated parking garage 100 that comprises a plurality of modules that further comprise additional entry level carriers 116 and terminals 118. In this example there are two entry level carriers 116 and two upper horizontal modules 112 for an arrangement of three vertical lift carriers 110 and ten vertical storage units 108. In this example, there are two vertical storage units 108 on each end 202, 204 of the section 200 and three vertical storage units 108 between each vertical lift carrier 110 to further illustrate the flexibility of the modular configuration described herein.

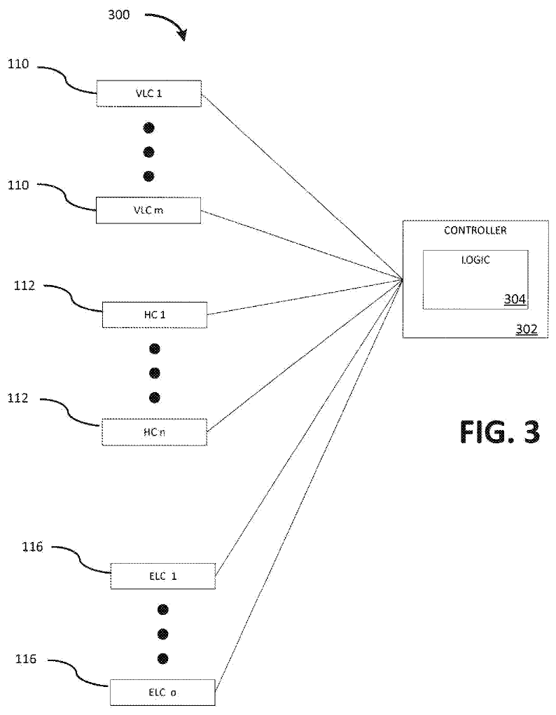

FIG. 3 is a block diagram illustrating an example of a system 300 for operating an automated parking garage (e.g., automated parking garage 100) in accordance with an example embodiment. The system comprises a plurality of vertical lift carriers (VLC 1 . . . VLC m, where m is an integer greater than 1) 110, upper horizontal carriers (HC 1 . . . . HC n, where n is an integer greater than 1) 112, and a plurality of entry level carriers (ELC 1 . . . ELC o, where o is an integer greater than 1) 116 that are coupled with a controller 302. As will be described herein, the controller 302 is operable to control the movement of the plurality of vertical lift carriers 110, upper horizontal carriers 112, and entry level carriers 116 so that a plurality of vehicles can be moved concurrently or simultaneously. The control 302 comprises logic 304 that performs the functionality described herein. “Logic,” as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully implemented in software that is embodied on a tangible, non-transitory computer-readable medium that performs the described functionality when executed by processor.

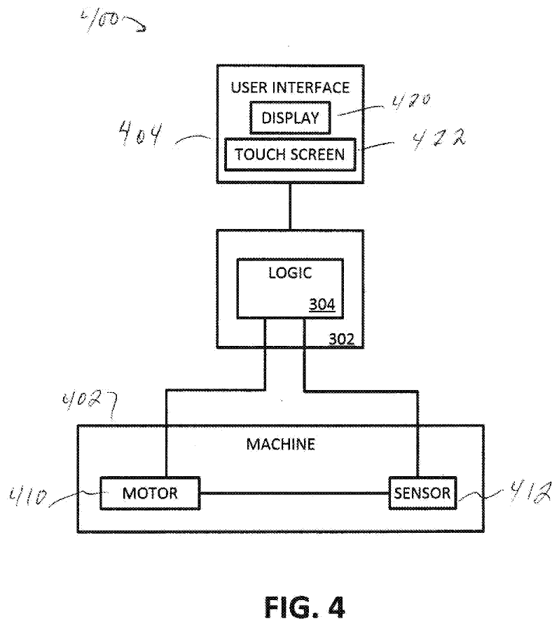

FIG. 4 is a block diagram illustrating an example of a system 400 that can be employed by a robotic parking garage 100 that comprises a controller 302 for controlling a machine 402 associated with the robotic parking garage and a user interface 404 that enables an operator to obtain real time data about the machine and interact with the controller to control operation of the machine.

The machine 402 comprises a motor 410 and a sensor 412, and may be any suitable type of equipment employed in a robotic parking garage. Examples, include, but are not limited to a carrier module (e.g., an upper horizontal carrier 112 and/or an entry level carrier 116, which may also include a turn table), a vertical lift carrier 110, a rack entry module, a pallet vertical lift, and pallet shuttle (see e.g., U.S. Pat. No. 6,851,921, which is incorporated by reference herein in its entirety for an example of a rack entry module, a pallet vertical lift, and a pallet shuttle; see also, US Patent Application Publication No. 2015/0175354, incorporated by reference herein in its entirety for an example of a turn table).

The motor 410 is controlled and monitored by controller 302. Examples of the type of motor for motor 410 include, but are not limited to, an electric motor, a servomechanism, and a stepper motor. The movement of the motor 410 is controlled by the controller 302. In an example embodiment, the controller sends a signal to the motor 410 which causes the motor 410 to move a distance specified by the controller 302. In another example embodiment, the controller 302 can cause motor 410 to rotate a specified number of times, and in particular embodiments at a specified speed (e.g., revolutions per minute or “RPMs”).

The sensor 412 can be any suitable device for measuring a desired movement of the motor 410 and provides data representative of movement of the motor 410 to the controller 302. In an example embodiment, the sensor 414 can employ an encoder to measure rotation of a shaft. In another example embodiment, the sensor 414 comprises reflective tape and an optical scanner and measures the number of rotations. In an example embodiment, the sensor 412 can sense the position of an object coupled with the controller and for example can determine when the object has moved from a first position to a second position and the second position to the first position (e.g., lift up or down for a pallet stacker). In an example embodiment, the controller 302 monitors how many times the motor performs a certain function (e.g., lift up or down for a pallet stacker). Further examples of the types of sensors 412 and data provided by the sensors 412 and the data maintained by the controller 302 will be described herein infra.

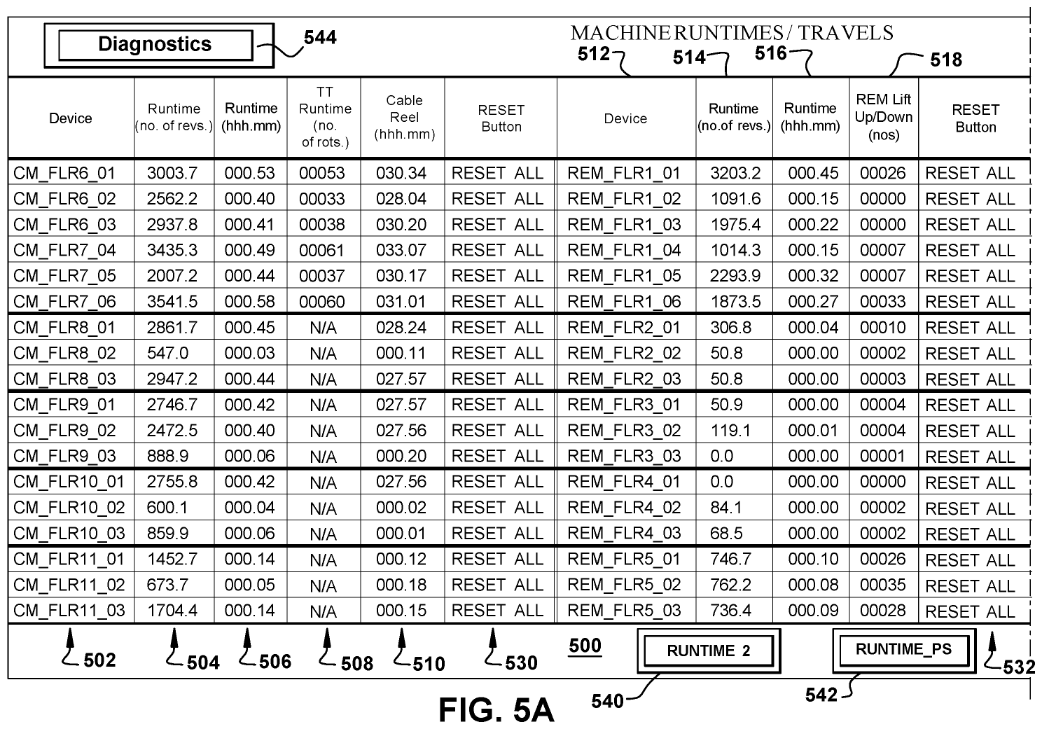

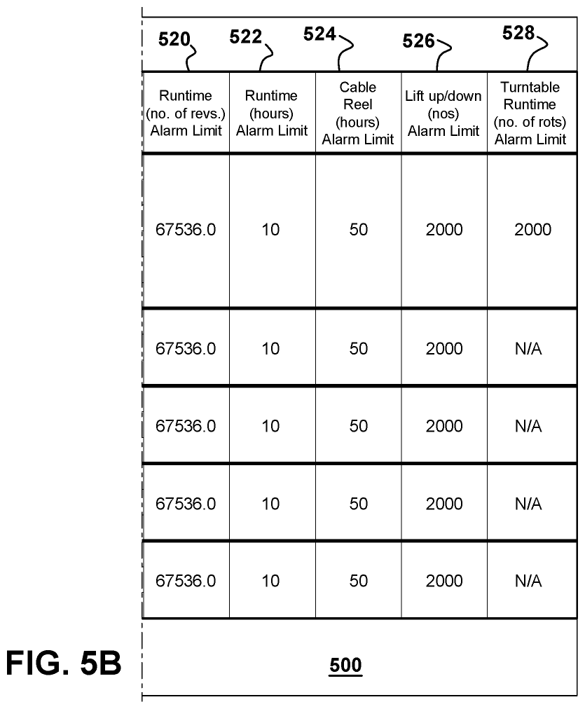

The user interface 404 comprises a display 420 and an input device 420, which in the illustrated example is touch screen but in other embodiments can employ other devices, such as for example, a mouse and/or keyboard. The data displayed on display 420 and the inputs that can be received by the input device 422 can improve an operator's ability to interact with the control system 302 for controlling and/or maintaining the machine 402. FIGS. 5-7 illustrate three embodiments of the user interface 400 that provide runtime data, thresholds where an alarm is generated if exceeded, and the ability change the thresholds and reset the runtime data when maintenance on a machine 402 and/or a machine's motor 404 is completed.

As those skilled in the art can readily appreciate, the number of controllers 302, machines 402, and user interfaces 420 were selected merely for ease of illustration. In example embodiments, the system 400 can comprise any physically realizable number of controllers 302, machines 402, and user interfaces 420. Thus, the principles described herein should not be limited to the number of elements described in FIG. 4.

FIG. 5 illustrates an example of a first user interface screen 500 for providing runtime data and providing inputs for maintaining a first plurality of robotic parking garage machines. The display 420 is broken down into three parts for each machine, for example columns 502 and 512 identify the machine. Columns 504, 506, 508 [provide runtime data for the corresponding machine in column 502 and columns 514, 516, 518 provide runtime data for the corresponding machine in column 512. Columns 520, 522, 524, 526, 528 provide threshold data for generating alarms.

For example, column 502 provides data representative of the identification of the carrier modules (CM, which can be an ELC 116 on the first floor or an HC 112 on upper floors), the floor (FLR) the module is located on, and a module number for the floor. For example, for the first floor there are six carrier modules (CM_FLR1_01, CM_FLR1_02, CM_FLR1_03, CM_FLR1_04, CM_FLR1_05, CM_FLR1_06) on the second floor three carrier modules (CM_FLR2_01, CM_FLR2_02, CM_FLR2_03), on the third floor three carrier modules (CM_FLR3_01, CM_FLR3_02, CM_FLR3_03), on the fourth floor three carrier modules (CM_FLR4_01, CM_FLR4_02, CM_FLR4_03) and on the sixth floor three carrier modules CM_FLR5_01, CM_FLR5_02, CM_FLR5_03). Column 512 provides the identification of the Rack Entry Module (REM) corresponding to the carrier module identified in column 512 (e.g., REM_FLR1_01 corresponds to CM_FLR_01, REM_FLR1_02 corresponds to CM_FLR1_02, etc.).

Column 504 provides a Runtime, number of revolutions for the corresponding machine in column 502. Column 506 provides a Runtime operating time (hours:minutes or “hh:mm) for the corresponding machine in column 502. Column 508 provides the turntable (TT) Runtime operating time for the corresponding machine in column 502. Column 510 provides a Runtime operating time for the corresponding machine in column 502. Columns 520, 522, 524 provide the alarm threshold limits for the data in columns 504, 506, 508, 510 respectively. If a runtime value exceeds the threshold value, then the controller 302 causes the runtime data that exceeds the value to be displayed in a second color (e.g., red). In particular embodiments, if a runtime value is within a predefined threshold of the alarm threshold (e.g., with a certain %, number of revolutions, time, and/or number of rotations), the controller causes the runtime data to displayed a third color (e.g., yellow, indicating maintenance is due soon).

Column 514 provides a Runtime, number of revolutions for the corresponding machine in column 512. Column 516 provides a Runtime operating time for the corresponding machine in column 512. Column 516 provides the number of times the Rack Entry Module (“REM”) lifted has moved up and down for the corresponding machine in column 512. Columns 520, 522, 526, provide the alarm threshold limits for the data in columns 514, 516, 518 respectively. If a runtime value exceeds the threshold value, then the controller 302 causes the runtime data that exceeds the value to be displayed in a second color (e.g., red). In particular embodiments, if a runtime value is within a predefined threshold of the alarm threshold (e.g., with a certain %, number of revolutions, time, and/or number of rotations), the controller causes the runtime data to displayed a third color (e.g., yellow, indicating maintenance is due soon).

Columns 520, 522, 524, 526, 528 provide alarm data that for any row can be modified by an operator of the user interface 402. For example using an input such as a touch screen 422 or other input device such as a mouse, the operator can select an alarm threshold value to modify and type in a new value with a keyboard or scroll through values and select a new value with a pointing device or touch screen 422. In the illustrated example, the alerts are set for devices by floor. For example for the all the floors the threshold for the number of revolutions for carrier modules is 67536.0, however, the operator can change the limits for any floor to another value.

Column 530 is an input to reset the runtime values (columns 504, 506, 508) for the machine in column 502 on the same row. The operator can select the button in column 530 to reset (e.g., set the accumulated values to 0) the runtime values for a machine after maintenance on the machine is completed. Similarly, Column 532 is an input to reset the runtime values (columns 504, 506, 508) for the machine in column 512 on the same row. The operator can select the button in column 532 to reset (e.g., set the accumulated values to 0) the runtime values for a machine after maintenance on the machine is completed.

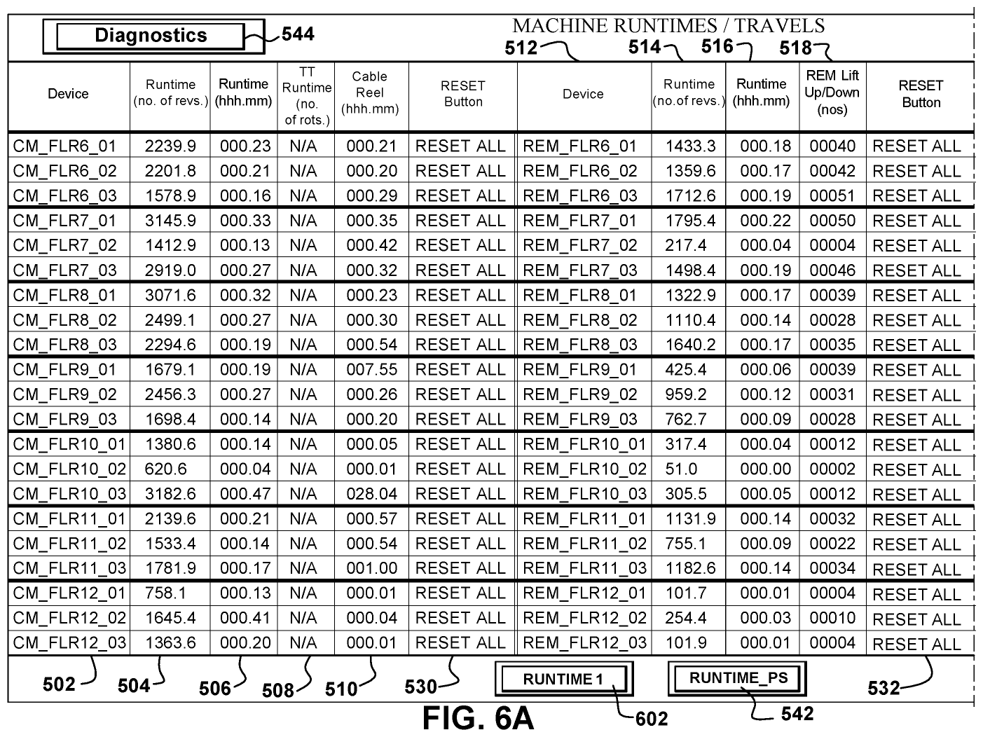

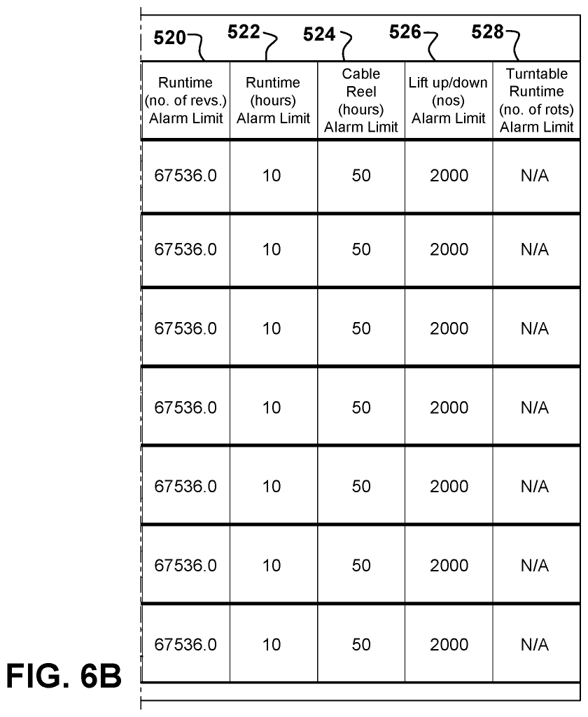

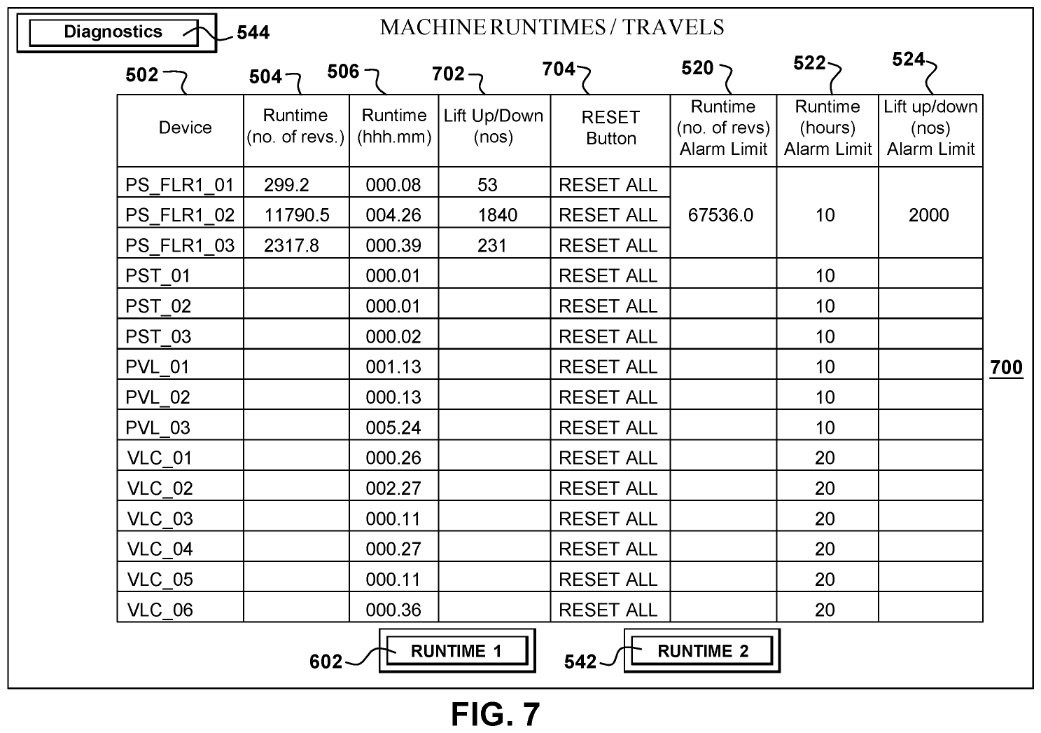

Button 540 is an input for switching the user interface 404 to the second runtime screen (Runtime 2, an example of which is provided in FIG. 6 described herein infra) for carrier modules. Button 542 is an input for switching the user interface to the Runtime Pallet Shuttle screen. Button 544 is an input for switching the user interface 404 to the Pallet Shuttle runtime screen (Runtime_PS), an example of which is provided in FIG. 7).

In the above examples, some of the columns may not display any data (or N/A) because that data is either not pertinent or available for the corresponding machine. For example, in the illustrated example turntables are only located on the first floor, so there would be turntable data for the first floor and no turntable data floors 2-5.

FIG. 6 illustrates an example of a second user interface screen 600 for providing runtime data and providing inputs for maintaining a second plurality of robotic parking garage machines. The interface 600 provides data for carrier modules (HC 112) on floors 6-12. Like the example in FIG. 5, the colors of values displayed in columns 504, 506, 508, 514, 516, 518 can change if they exceed the appropriate threshold displayed in columns 520, 522, 524, 526, 528. Likewise the values stored in any row of columns 520, 522, 524, 526 can be changed, Button 602 is an input that provides the ability to switch the user interface 404 to screen 500 described in FIG. 5.

FIG. 7 illustrates an example of a third user interface screen 700 for providing runtime data and providing inputs for maintaining a third plurality of robotic parking garage machines. Screen 700 is able to provide data representative of runtime data for a Pallet Shuttle (PS), a Pallet Stacker (PST), a Pallet Vertical Lift (PVL), and a Vertical Lift carrier (VLC) 110. The data provides by this screen 700 comprises data identifying the machine in column 502. Column 504 provides a Runtime, number of revolutions for the corresponding machine in column 502. Column 506 provides a Runtime operating time (hours:minutes or “hh:mm) for the corresponding machine in column 502. Column 702 provides a Runtime value for the number of lifts performed by the motor. Column 704 Column is an input to reset the runtime values (columns 504, 506, 702) for the machine in column 502 on the same row. The operator can select the button in column 704 to reset (e.g., set the accumulated values to 0) the runtime values for a machine after maintenance is completed. In an example embodiment, the color for a value in columns 504, 506, 702 that exceed the pertinent threshold in one of columns 520, 522, 526 are displayed in a different (e.g., second) color from those values that do not exceed the pertinent threshold in one of columns 520, 522, 526 (e.g., first color). The values in columns 520, 522, 526 are modifiable. For example using an input such as a touch screen 422 or other input device such as a mouse, the operator can select an alarm threshold value to modify and type in a new value with a keyboard or scroll through values and select a new value with a pointing device or touch screen 422. In an example embodiment as illustrated in FIG. 7, the devices on the screen 700 are grouped by device type (PS, PST, PVL, VLC) and not by device type and floor like in FIGS. 5 and 6.

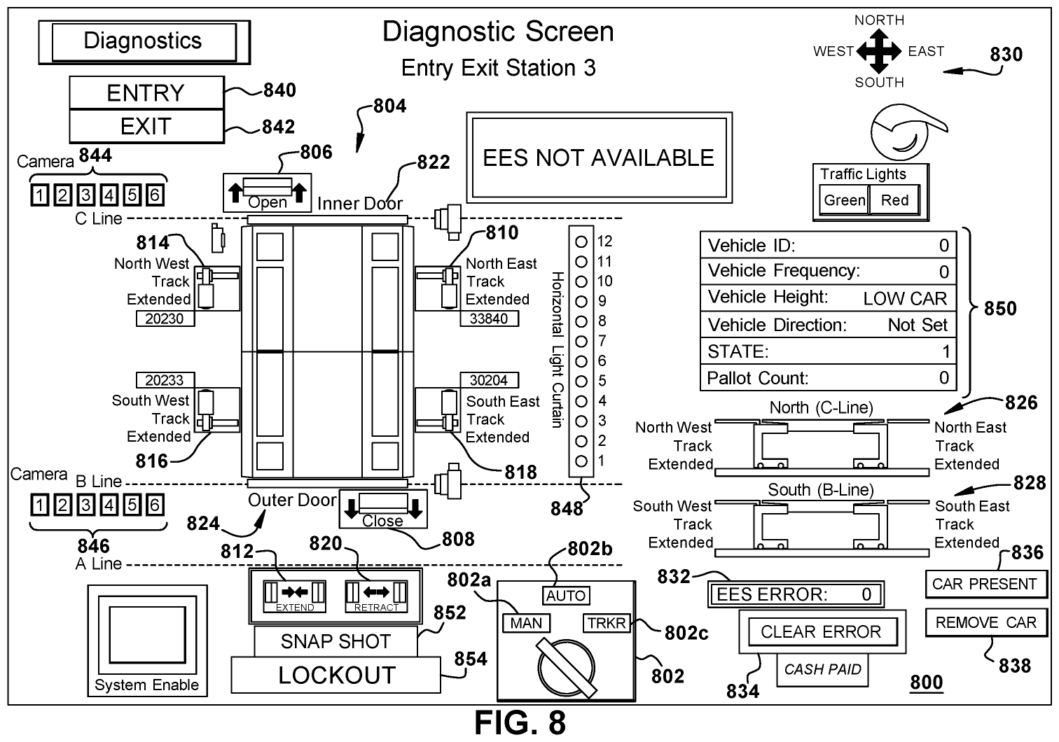

FIGS. 8-15 illustrate examples of diagnostic screens for machines associated with a robotic parking garage 100. In certain modes the user provided inputs cause components of the machine to move and/or perform a designated function. Code in the machine or machine component moves or performs the user input function. These modes are sometimes referred to herein as L−1 mode. For example, in manual mode operator inputs are employed to control the machine with safety interlocks bypassed. This mode can be useful when performing maintenance on a machine. In a first auto mode (also a L−1 mode), the machine is operated in response to user inputs with safety interlocks engaged. In a second auto mode (which may be referred to herein as “autonomous” or “L−2 mode”, the computer (or controller) inputs operate the machines. In L−2 mode, a plurality of machines can be operated concurrently and/or simultaneously by the computer with safety interlocks engaged. Although three modes are described herein, those skilled in the art can readily appreciate that any physically realizable number of modes can be employed and that the number of modes were selected merely for ease of illustration.

As those skilled in the art can readily appreciate, not all of the visual representations and/or inputs for a particular diagnostic screen are available for all modes of operation. For example, inputs that allow a machine to bypass certain limits may be available in manual mode for maintenance and testing operations and unavailable in other modes.

FIG. 8 illustrates an example diagnostic screen 800 for an Entry Exit Station 118 that can be employed by user interface 404 to allow an operator to interact with the components of the Entry Exit Station 118. This screen 800 provides the status of the components of an entry exit station 118 and if there is a malfunction, what component of the entry exit station 118 or what sensor is not working or causing a problem. Additionally, in certain (e.g., L1) modes (see e.g., description of switch 802 below), the operator can cause the entry exit station 118 to perform any function.

The switch 802, allows the operator to control how the entry exit station 118 operates. For example, in MAN (Manual) mode 802a, the operator manually operates the components within the entry exit station 118 by inputting commands and safety interlocks are bypassed. AUTO mode 802b corresponds to the first auto mode where the operator inputs commands to operate the components within the entry exit station with the safety interlocks engaged. TRKR mode 802c corresponds to the autonomous (or L−2) mode where the EES 118 a computer provides the inputs to the EES 118.

The screen 800 further comprises a graphical display 804 illustrating the status of the components of the entry exit station 118. An input 806 allows the operator in L−1 modes 802a or 802b to cause the controller 302 to send a signal to the entry exit station 118 to open or close the inner door of the entry exit station 118. Area 822 provides a graphical illustration of the inner door (e.g., one color, such as green, for the door being open and a second color, such as red, for the being closed). In the illustrated example, the inner door is closed, the input 806 indicates that selecting the input 806 will cause the controller 302 to send a signal to the entry exit station 118 to cause a motor coupled with the inner door to open the inner door.

The screen 800 further comprises an input 808 that allows the operator in the L−1 modes 802a, 802b to provide an input that cause the controller 302 to send a signal to the entry exit station 118 to open or close the outdoor door of the entry exit station 118. Area 824 provides a graphical illustration of the inner door (e.g., one color, such as green, for the door being open and a second color, such as red, for the being closed). In the illustrated example, the outer door is open, thus the input 808 indicates that selecting the input 808 will cause the controller 302 to send a signal to the entry exit station 118 to cause a motor coupled with the out door to close the outer door.

The screen 800 further comprises indicators 810, 812, 814, 816 that provide the status of the track (extended or retracted) for the North East, South East, North West, and South West tracks respectively. In L−1 modes 802a, 802b, inputs 818 and 820 can be employed to cause the controller 302 to send a signal to the entry exit station 118 to extend or retract, respectively, the tracks. The status of the tracks is also displayed in areas 826, 828 where area 826 provides a graphical illustration of the North (East and West) side of the entry exit station 118 and area 828 provides a graphical illustration of the South (East and West) side of the entry exit station 118. The directional orientation (North, South, East, West) is provided in the upper left area of screen 800 as indicated by 830.

If an error is detected, an error code is displayed in the area represented by 832. Some example error codes that can be displayed are 1=Tracks Have Taken Too Long to Open or Close, 5=Outer Door Timeout When Opening Door. 6=Outer Door Timeout When Closing Door, 7=Inner Door Timeout When Opening Door, 8=Inner Door Timeout When Closing Door, 17=An EES Door Overload Has Tripped, 20=EES System Not Enabled, 31=The EES is Not in a Valid State, 32=The EES State is Zero, and 88=A Pallet Shuttle is Requesting an Interlock, But the Floor and Row Don't Match. The error code represented by 832 can be cleared by selecting input 834.

The area represented by 836 indicates whether a car is present in the Entry Exit Station 118. In an example embodiment, a first color (e.g., red) can be employed to indicate when a car is present in the Entry Exit Station 118 and a second color (e.g., green) can be employed to indicate there is no car present in the Entry Exit Station 118. If there is a car present in the Entry Exit Station, input 838 can be employed to remove the car from the Entry Exit Station 118. For example, the car can be transferred to an Entry Level Carrier 116.

Areas 840, 842 can be employed as both a display to indicate whether the EES 118 is operating in Entry or Exit mode, and as an input to cause the controller 302 to send a signal to the entry exit station 118 to change the operating mode when in the L−1 modes 802a, 802b. For example, a first color (e.g., green) can be employed to by one of areas 838, 840 to indicate whether the EES 118 is operating as in Entry or Exit mode. In the L−1 modes 802a, 802b, the operator can selecting area 840 to put the EES 118 into Entry Mode or select area 842 to put the EES 118 into exit mode.

The screen 800 further comprises inputs 844, 846 that allow an operator to select a camera for viewing the interior of the EES 118. The buttons along input 844 are employed to select one of five cameras on the North (or inner) side of the EES 118. The buttons along input 846 are employed to select one of five cameras on the South (or outer) side of the EES 118.

The screen further comprises an area 848 which indicates the status of the horizontal light curtain. In an example embodiment, the horizontal light curtain 848 employs a first color (e.g., green) to indicate to a driver they can safely move their vehicle, and a second color (e.g., red) to indicate to a driver they should stop moving.

In an example embodiment, the screen 800 further comprises an area 850 for providing information regarding a vehicle in the EES 118 and whether there is a pallet in the EES 118. For example, the area 850 can display an identification associated with the vehicle, vehicle height, vehicle direction/orientation (front side pointed toward inner door or outer door).

In an example embodiment, the screen 800 comprises area 850, 852 which provide status data and are also inputs for either obtaining a snap shot of the current diagnostics of the EES 118 or to lockout the EES 118. A first color (e.g., red) can be employed to indicate whether the EES 118 is in snap shot (area 852) or lockout (area 854) mode. Selecting area 852 will provide a diagnostic screen 800 of the EES 118. Selecting area 854 is employed to lockout the EES 118.

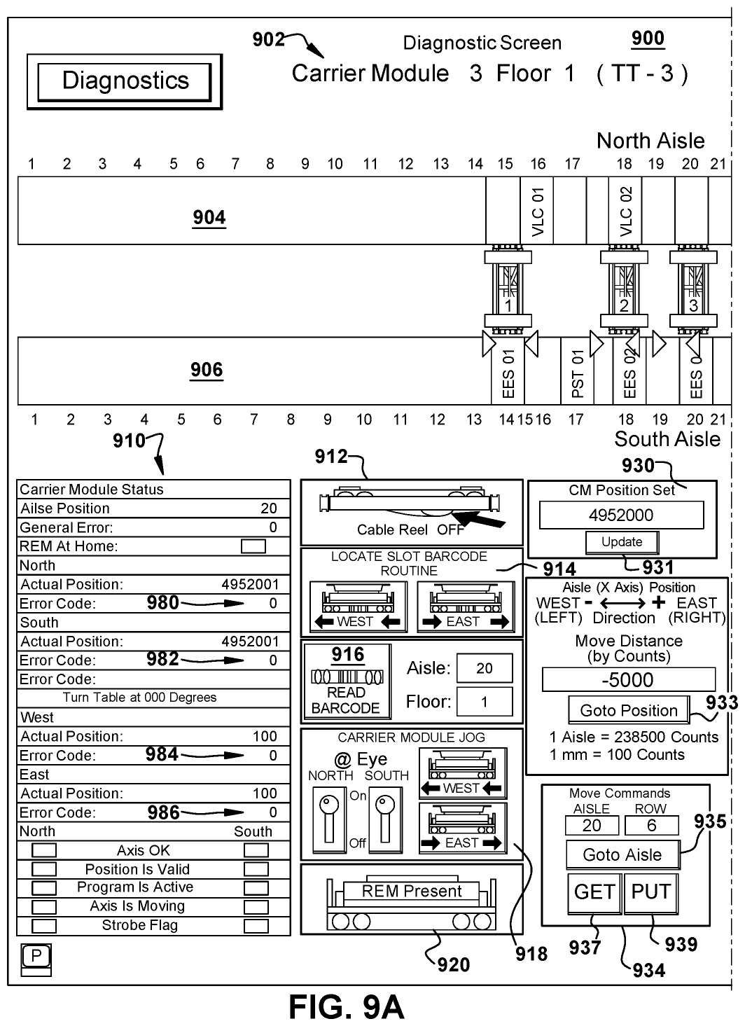

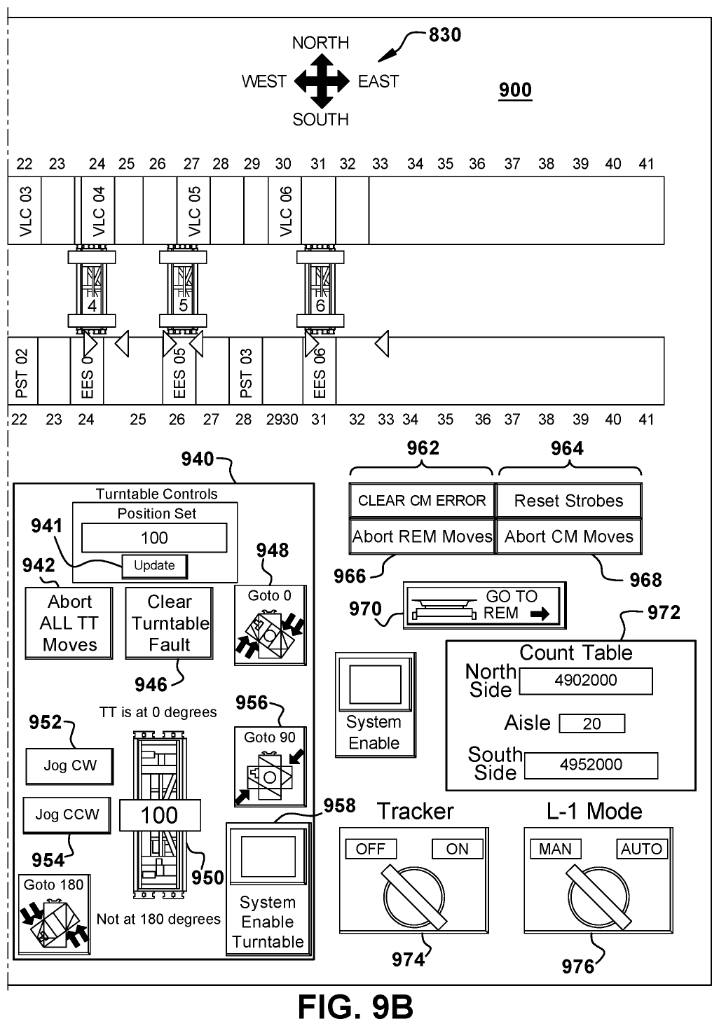

FIG. 9 illustrates an example diagnostic screen 900 for a first floor Carrier Module. which is also referred to herein as an Entry Level Carrier module (ELC) 116 that can be employed by user interface 404 to allow an operator to interact with the components of the ELC 116. The screen 900 provides the status of the components of an ELC 116 and if there is a malfunction, what component of the ELC 116 or what sensor is not working or causing a problem. In manual mode (see e.g., description of switch 976 below), the operator can cause the ELC module 116 to perform any function employing the inputs described herein.

Data representative of the Carrier Module that is being displayed is represented by 902. Data representative of the aisles associated with the carrier module 116 are represented by 904, 906. On the north aisle 904 are indicated the location of vertical lift carriers (VLC) and on the south aisle 906 the locations of entry exit stations, and

Status data of the carrier module 116 is displayed in the area indicated by 910. This data may include, but is not limited to, The position, presence of a rack entry module (REM), and as will be described in more detail herein, infra, error codes 980, 982, 984, 986. Button 912 indicates whether the cable reel is on or off and can be employed to turn the cable reel on and off by pressing button 912. In an example embodiment, button 912 is red in the off state and green in the ON state. The area represented by 914 can be employed to manually cause the controller 302 to send a signal to the ELC 116 to move the carrier module in one direction or another to locate a barcode associated with various destinations (e.g., VLC, EES, PST). The area represented by 916 provides data from a barcode reader that indicates the location of the ELC 116. The carrier module jog button 918 is employed to move at a pre-defined velocity, and the major Interlocks are bypassed in this state. This button is operable in manual mode. The area represented by 920 indicates whether a REM is present on the ELC 116.

In an example embodiment, the area represented by 930 provides the coordinates of the ELC 116. The update button 931 allows an operator to manually update the position of the ELC 116.

In an example embodiment, the area represented by 932 provides an X-axis position of the ELC 116. Input button 933 allows an operator to cause the controller 302 to send a signal to the ELC 116 to move the ELC 116 along the axis a designated distance.

In an example embodiment, the area represented by 934 provides an interface that displays location data of an ELC 116 and allows an operator to move the ELC 116. Input button 935 is a manual command to cause the controller 302 to send a signal to the ELC 116 to move the ELC 116 to a designated location. Button 937 is employed to get a pallet (which may or may not have a vehicle) from a storage location, and input button 939 is employed to put the pallet currently on the ELC 116 into a storage location.

In an example embodiment, turntable control is provided by the interface illustrated in the are designated by 940. The position of the turntable is indicated by the graphic indicated at 950. The position of the turntable can be updated by employing input button 941. The operator can abort all turntable moves by selecting input button 942. A turntable fault is cleared by selecting input button 946. The operator employs input button 948 to cause the controller 302 to send a signal to the ELC 116 to move the turntable to a predefined position (“0” in this example). The operator can jog (e.g., move the machine at a very show speed while in Manual mode which can be helpful for performing maintenance on the machine) the turntable in the clockwise direction by selecting input button 952. The operator can jog the turntable in the counterclockwise direction by selecting input button 954. Input buttons 956, 960 cause the turntable to move to predefined positions. Input button 958 is employed to enable the turntable.

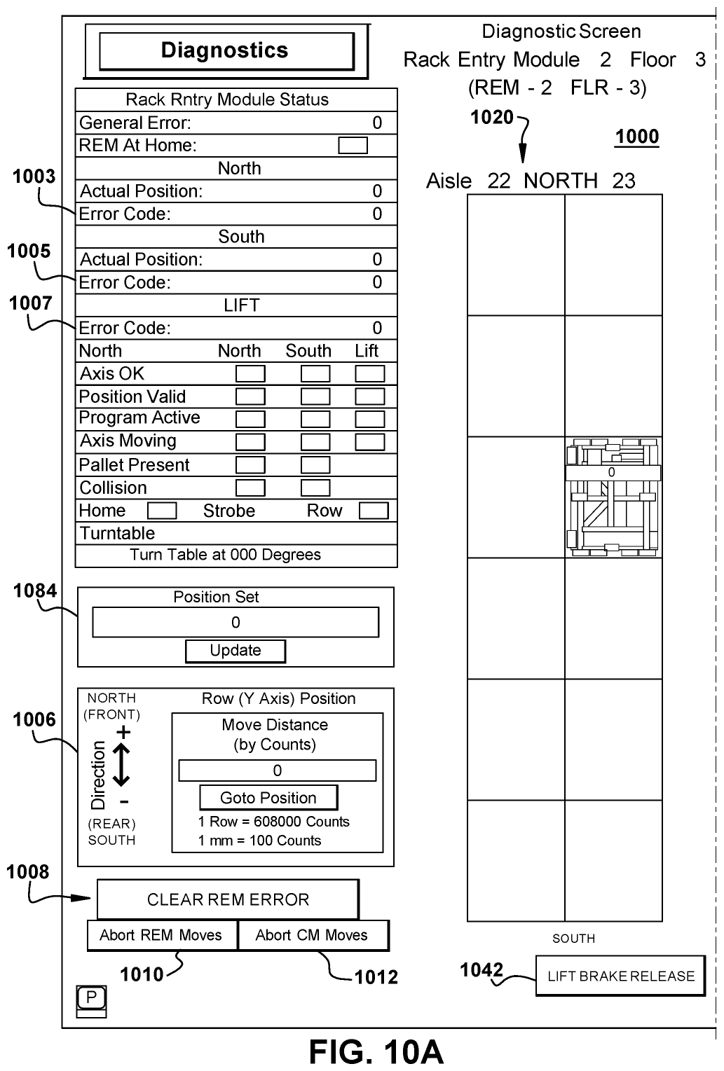

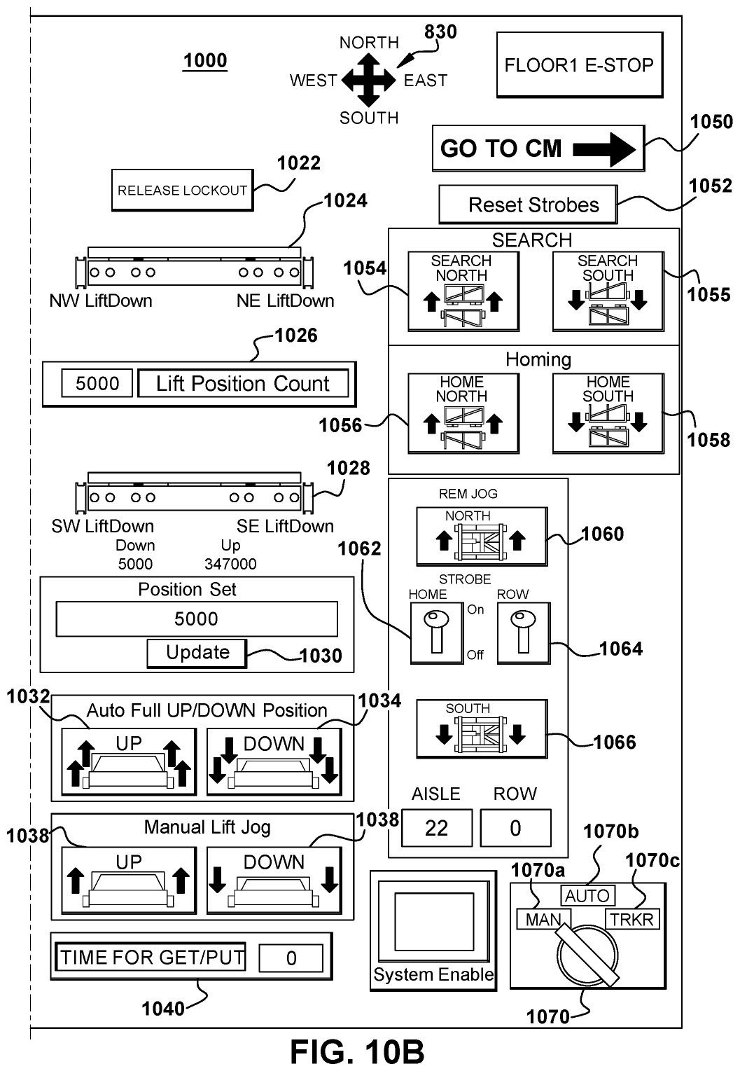

In an example embodiment, input button 962 is employed to clear a carrier module error. Input button 964 resets the carrier module's strobes. Input button 970 switches the display to the REM diagnostic screen 1000 described in FIG. 10. Area 972 provides data representative of a count table which provides data representative of a distance from various points of interest. In an example embodiment, one count equals one millimeter. Switches 974, 976 are employed to select the operating mode. In an example embodiment, Switch 974 OFF and switch 976 MAN is a manual mode of operation (operator inputs, at least one safety interlock bypassed), switch 974 OFF and switch 976 AUTO is a first auto operating mode (operator inputs, safety interlocks engaged), and switch 974 ON and switch 976 AUTO is a second auto mode, or autonomous mode (computer inputs and safety interlocks on).

The Error code displayed at 980 is for the REM on the North Aisle in the illustrated example. The Error code displayed at 982 is for the REM on the South Aisle in the illustrated example. The Error code displayed at 984 is for the turntable West of the ELC 116 in the illustrated example. The Error code displayed at 986 is for the turntable East slot of the ELC 116 in the illustrated example. Examples of error codes and their meanings displayed at one of 980, 982, 984, 986 include but are not limited to 2=System Not Enabled, 3=Collision Detected, 13=Master Control Relay Not On, 14=South Amplifier Contactor Not On, 15=North Amplifier Contactor Not On, 16=West Turn Table Amplifier Contactor Not On, 17=East Turn Table Amplifier Contactor Not On, 18=Turn Table Not At 0 Degrees, 19=Turn Table Not At 180 Degrees, 30=North Strobe Not Seen When Moving to North Side Aisle, 31=South Strobe Not Seen When Moving to South Side Aisle, 35=One Axis Moving When Other is Stopped, 40=Turn Table Too Close to Object to Rotate, 47=Barcode Read Doesn't Match Commanded Aisle to Move to, 48=Move Completed but Barcode Not Read, 49=Commanded Aisle To Go To Overlaps with Deckmate, 50=Window Overlaps with Deckmate's Window, 58=Turn Table Program Running Timeout, 60=Cable Reel Motor Overload Tripped, 102=Collision Sensor Not On When Next to Wall, 103=Collision Sensor Not On When Next to Deckmate, 104=EGD Exchange to West Deckmate Down, 105=EGD Exchange to East Deckmate Down, 122=Cable Reel Did Not Pull in Cable After REM Movement, and 150=Abort All Servo Moves Occurred.

FIG. 10 illustrates an example diagnostic screen 1000 for a Rack Entry Module (REM) that can be employed by user interface 404 to allow an operator to interact with the components of the REM This screen 1000 provides the status of the components of an REM and if there is a malfunction, what component of the REM or what sensor is not working or causing a problem.

The screen 1000 comprises a first area 1002 that provides status data for the REM. In an example embodiment, the status data includes the position of the REM, and whether there is a pallet present on the REM. As will be described herein, infra, the status information includes data representative any error conditions detected.

At 1004, there is provided an input to update the position of the REM. An update is provided to perform this function.

The area bounded by 1006, provides an input to move the REM to another position. Entering a value (counts) for how to move the REM and selecting the GoTo Position button causes the controller 302 to send a signal to the REM to move the amount (value) specified.

Input 1008 enables an operator to clear an REM error. Input 1010 will cause the REM to abort moves and input 1012 will abort the moves of the CM associated with the REM.

The area represented by 1020 provides a graphical view of the real-time position of the REM within the robotic parking garage 100. In the illustrated example, the REM is in front of EES3.

Input 1022 provides an input to release a lockout. The area represented by 1024 illustrates the position of the (Northwest) NW and (Northeast) NE (or first and second) corners of the lift of the REM. Input 1026 provides the ability for an operator to move the lift position by a specified amount (count). The area represented by 1028 illustrates the position of the (Southwest) SW and (Southeast) SE (or third and fourth) corners of the lift of the REM. Input 1032 causes the controller 302 to send a signal to the REM to moves the lift to the full up position. Input 1034 moves the lift to the full down position. Input (or lift jog button) 1036 causes the controller 302, when in manual mode, to send a signal to the REM to move (jog) the lift in the up direction at a pre-defined velocity, which is typically a very show speed that is useful while performing maintenance. Similarly, Input 1038 causes the controller 302, when in Manual mode, to send a signal to the REM to move the lift in the down position at a predefined velocity. The Time for Get/Put area 1040 of the screen displays the total time for getting or putting a vehicle or pallet from a slot or VLC. The Brake Release area of the screen 1042 displays the status of the brake in the lift motor. In an example embodiment, the color green represents that the break is released and the color red indicates that the brake is not released.

Input 1050 retrieves the carrier module diagnostic screen for the carrier module associated with the REM. For example, the carrier diagnostic screen can be screen 900 for an entry level carrier or screen 1100 for an upper level carrier.

In an example embodiment, a Search area on screen 1000 provides two inputs for searching for a position strobe. The position strobes are reflectors located at different positions. The REM employs a laser sensor installed in the REM to search for a position strobe to determine the position of the sides of the lift. Input 1054 searches the South (or first) side of the REM. Input 1055 searches the North (or second) side of the REM.

In an example embodiment, a Homing area of screen provides two inputs. Homing North . . . Homing South that bring the REM back to the home position, which is on top of the carrier module. If the REM is towards the South, Homing North is employed and vice versa.

In an example embodiment, the New Jog area of diagnostic screen provides inputs to jog (move a predefined distance) the REM The inputs comprise jog North 1060 (move a predefined distance in a first direction, e.g., North), and jog South 1066 (move a predefined distance in a second direction, e.g., South/Input 1062 switches the home strobe lights for the REM on or off. Input 1064 switches the strobe lights for the rows in the parking garage on or off.

Switch 1070 selects the operating mode for the REM. Position 1070a for manual operation, position 1070b for the first automatic operation mode (inputs from operator), and position 1070c (for a second (or fully) automatic operation mode (inputs from computer, e.g., autonomous).

Any errors that are detected with the REM are displayed at one of positions 1003 (North), 1005 (South) or 1007 (Lift). Examples of error codes and definitions for the error codes for a REM include, but are not limited to 2=System Not Enabled, 3=Collision Detected, 31=Move Aborted, 51=REM Commanded Aisle Doesn't Match CM Aisle, 52=REM Commanded Row Doesn't Match CM Row, 53=Commanded Row Out of Range, 54=Obstruction in Rows 2, 3, or 5, 55=Obstruction in Rows 2 or 3 when Getting from Row 1 or 4, 56=Ethernet Global Data (EGD) Communication Down with CM, 59=Pallet Not Present When Put Command Issued, 60=Pallet Present When Get Command Issued, 61=Lift in Up Position With No Pallet Present When Get/Put Issued, 62=Lift is in Down Position With a Pallet Present When Get/Put Issued, 63=Communication Down with VLC (which in this example is Ethernet Data Protocol “EGD”, a protocol to communicate between machines in the garage, however those skilled in the art can readily appreciate any suitable communication protocol can be employed), 64=EGD Communication Down with CM, 65=EGD Communication Down with PVL, 70=No Pallet Present When Get Command Issued, 75=Commanded Slot to Go To is Not Valid, 82=Cable Reel Overload When REM Moving to a Slot, 100=Command Timeout-No Movement after 30 Seconds, 101=Cable Reel Overload from CM, 102=Command Timeout-Carrier is Not in Position for REM to Move, 104=Pallet Not Seen by Collision Sensor in the destination Slot, 108=PUT Command Issued with PUT in Process, 109=GET Command Issued with GET in Process.

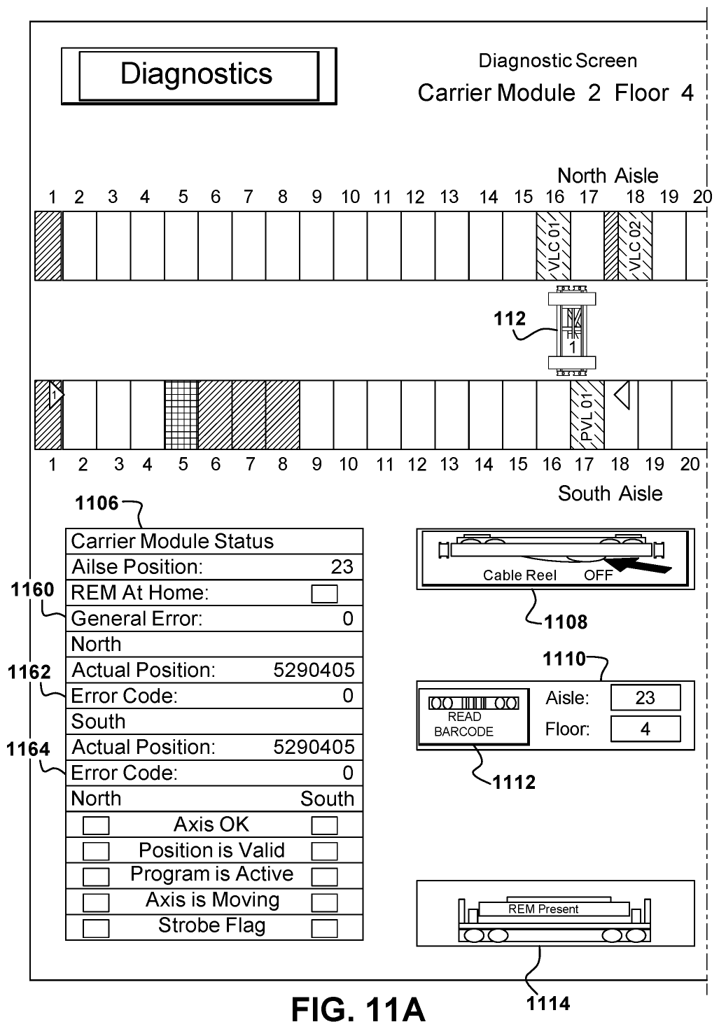

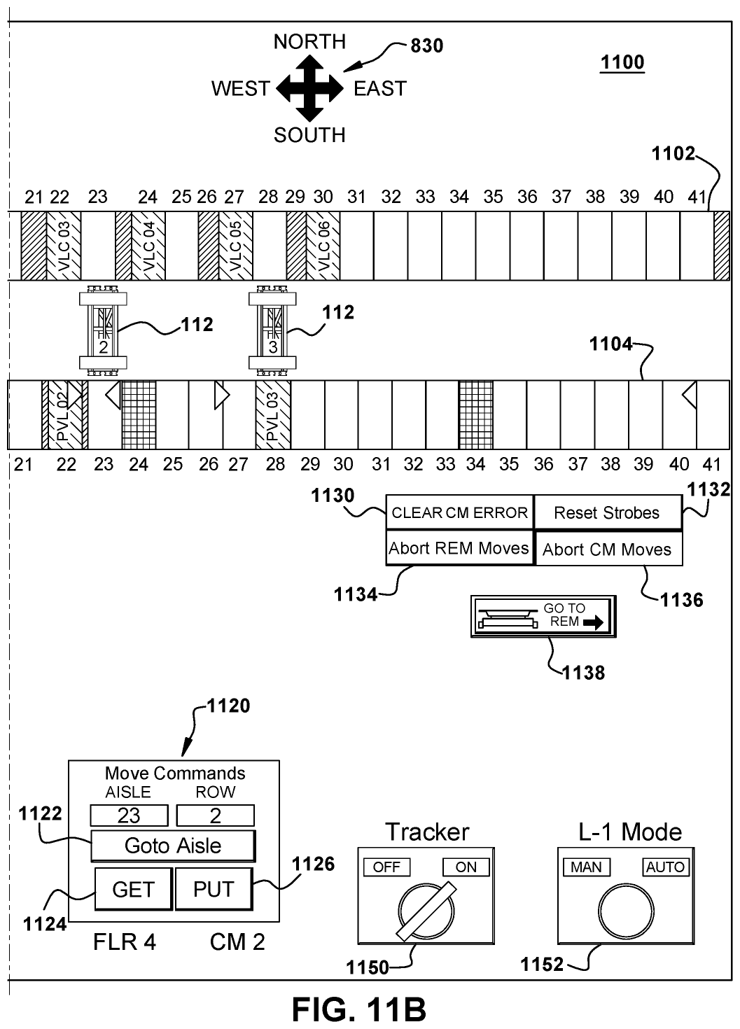

FIG. 11 illustrates an example diagnostic screen for an upper floor Carrier Module, also referred to herein as an upper Horizontal Carrier (HC) Module 112 that can be employed by user interface 404 to allow an operator to interact with the components of the HC module 112. Screen 1100 provides the status of the components of an HC module 112 and if there is a malfunction, what component of the HC module 112 or what sensor is not working or causing a problem. Additionally, as will be described below, the operator can manually control the HC Module by interacting with diagnostic screen 1100.

In the illustrated example, a first (North) aisle is represented by 1102 and a second (South) aisle is represented by 1104. The location of the vertical lift carriers (VLCs) are indicated on the North aisle 1102 and the location of Pallet Vertical Lifts (PLVs) are indicated on the South aisle 1104. The locations of the carrier modules 112 with respect to the North aisle 1102 and South aisle 1104 are provided.

Data representative of the carrier module 112 status is provided in the area represented by 1106. This data can include position of the module and as will be explained in more detail herein infra, any detected errors.

A graphical representation of the cable reel and its status is represented at 1108. Data representative of the aisle and floor of the carrier module is represented at 1110. An input 1112, can be employed manually causes the controller 302 to send a signal to the bar code reader on the carrier module 112 to read the bar code at the carrier module's 112 present location. A graphical representation of the REM position is provided at 1114.

Move commands are provided in the area represented by 1120 which also provides data representative of the aisle and floor of the carrier module. There is also provided an input 1122 where an operator can causes the controller 302 to send a signal to the carrier module 112 to move to a particular aisle. The input 1124 can be employed to causes the controller 302 to send a signal to the carrier module 112 to get a pallet from the current location. The input 1126 can be employed to causes the controller 302 to send a signal to the carrier module 112 to put a pallet at the current location.

In an example embodiment, the input represented at 1130 enables an operator to clear an error. The input represented at 1132 enables the operator to reset the strobes, which clears the last position search. The input represented at 1134 is employed to causes the controller 302 to send a signal to the carrier module 112 to abort REM moves. The input represented at 1136 is employed to causes the controller 302 to send a signal to the carrier module 112 to abort the carrier module's moves. The input represented by 1138 is employed to change the screen on the user interface 404 to the REM diagnostic screen 1000 (FIG. 10).

In an example embodiment, switches 1150, 1152 are employed to select the operating mode. In an example embodiment, Switch 1150 OFF and switch 1152 MAN is a manual mode of operation (operator inputs, at least one safety interlock bypassed), switch 1150 OFF and switch 1152 AUTO is a first auto operating mode (operator inputs, safety interlocks engaged), and switch 1150 ON and switch 1152 AUTO is a second auto mode, or autonomous mode (computer inputs and safety interlocks on).

In an example embodiment, detected errors are identified by error codes at the locations represented 1160, 1162, 1164. Examples of error codes and their meanings displayed at one of 1160, 1162, 1164 include but are not limited to 2=System Not Enabled, 3=Collision Detected, 13=Master Control Relay Not On, 14=South Amplifier Contactor Not On, 15=North Amplifier Contactor Not On, 30=North Strobe Not Seen When Moving to North Side Aisle, 31=South Strobe Not Seen When Moving to South Side Aisle, 35=One Axis Moving When Other is Stopped, 47=Barcode Read Doesn't Match Commanded Aisle to Move to, 48=Move Completed but Barcode Not Read, 49=Commanded Aisle To Go To Overlaps with Deckmate, 50=Window Overlaps with Deckmate's Window, 60=Cable Reel Motor Overload Tripped, 102=Collision Sensor Not On When Next to Wall, 103=Collision Sensor Not On When Next to Deckmate, 104=EGD Exchange to West Deckmate Down, 105=EGD Exchange to East Deckmate Down, 122=Cable Reel Did Not Pull in Cable After REM Movement, and 150=Abort All Servo Moves Occurred.

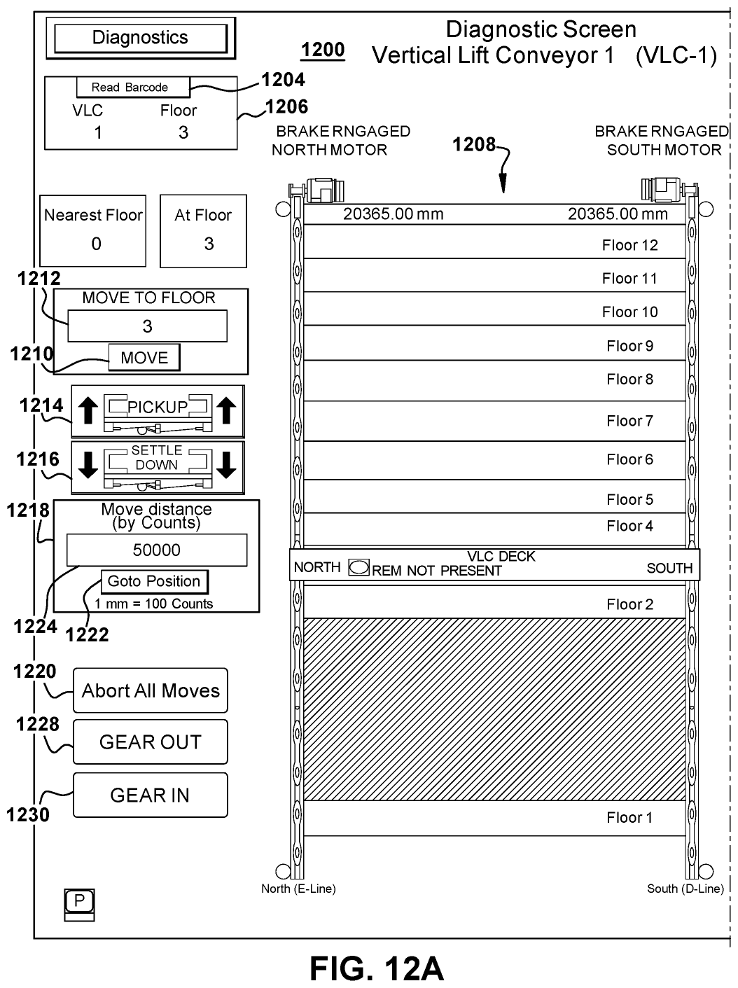

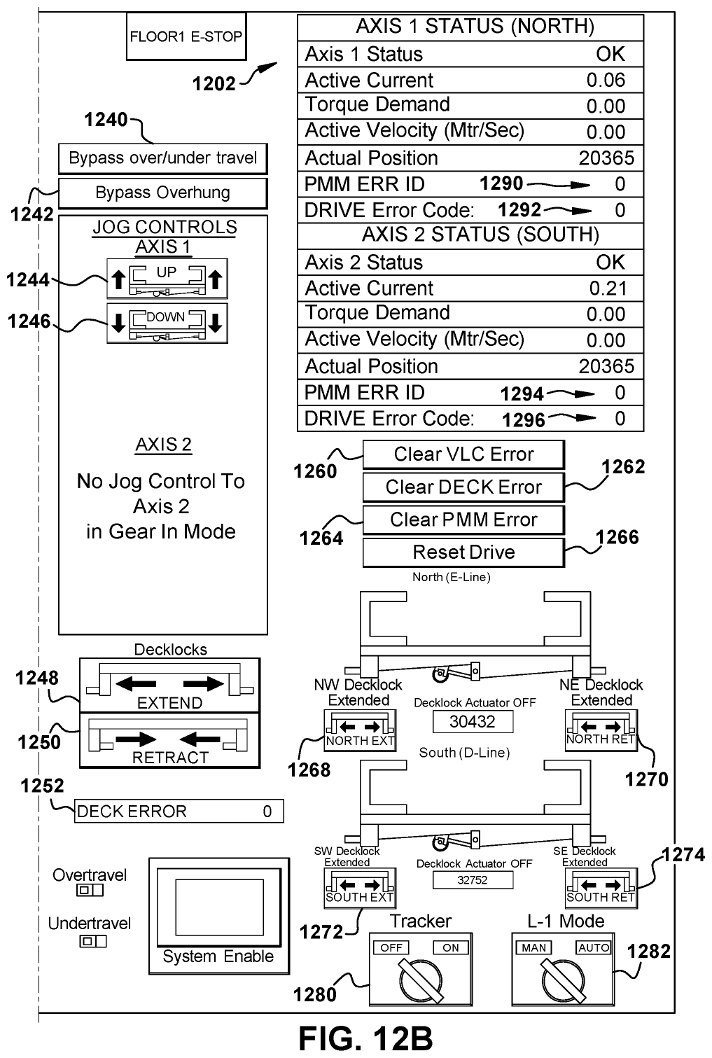

FIG. 12 illustrates an example diagnostic screen for a Vertical Lift Conveyer, also referred to herein as a Vertical Lift Carrier (VLC) module 110 that can be employed by user interface 404 to allow an operator to interact with the components of the VLC module 110. Screen 1200 provides the status of the components of an VLC module 110 and if there is a malfunction, what component of the HC module 112 or what sensor is not working or causing a problem. Additionally, as will be described below, the operator can manually control the VLC module 110 by interacting with diagnostic screen 1200.

The area represented by 1202 provides status information for the VLC module 110. The status information can include current location information, and as will be explained in more detail herein infra error codes for any detected errors.

The input at 1204 will cause the controller 302 to send a signal to a barcode reader (not shown) on the VLC 110 to read a barcode and the data read by the barcode reader (VLC number and floor) are displayed in the area represented by 1206.

The area represented by 1208 provides a graphical representation of the VLC 110. The graphical representation of the VLC 110 comprises the present position of the VLC 110.

In an example embodiment, the input 1210 is employed to causes the controller 302 to send a signal to VLC 110 to move the VLC 110 to a desired floor. The desired floor is input into the area represented by 1212.

In an example embodiment, the input 1214 causes the controller 302 to send a signal to VLC 110 to move the pallet shuttle up. Input 1216 causes the controller 302 to send a signal to VLC 110 to move the pallet shuttle down.

In an example embodiment, the area represented by 1218 is employed for moving the VLC 110 a desired distance. Selecting input 1222 moves the VLC 110 the distance specified at 1224.

In an example embodiment, input 1226 is employed to causes the controller 302 to send a signal to VLC 110 to abort all moves of the VLC 110. Inputs 1228 and 1230 are employed to control whether the motors in the VLC are in synch. Input 1228 causes the controller 302 to send a signal to VLC 110 to move the gear out (motors not in synch). Input 1230 causes the controller 302 to send a signal to VLC 110 to move the gear in (motors in synch).

In an example embodiment, selecting input 1240 causes the controller 302 to send a signal to VLC 110 to bypasses over/under travel. This is used to operate in Manual mode for testing the full up and down positions of VLC. Clicking this button will bypass the Auto Limit of Up and Down of the Lift. Input 1242 is selected to causes the controller 302, when in Manual mode, to send a signal to VLC 110 to bypass overhung limits. The overhung sensor is triggered if any object slips out of the pallet or protrudes out of the pallet while the lift is carrying the pallet.

In an example embodiment, selecting input 1244 causes the controller 302, while in manual mode, to send a signal to VLC 110 to move the shuttle lift a predefined distance in the upward direction. Selecting input 1246 causes the controller 302, while in Manual mode, to send a signal to VLC 110 to move the shuttle lift in a predefined distance in the downward direction.

In an example embodiment, selecting input 1248 causes the controller 302 to send a signal to VLC 110 to extend the deck locks. Selecting input 1250 causes the controller 302 to send a signal to VLC 110 to retract the deck locks. If there is a deck error, the error code is displayed at 1252. Examples of deck error codes include, but are not limited to 60=DC Power Supply Not OK, 61=North Decklock Overloaded, 62=South Decklock Overloaded, 63=Cable Reel Overloaded, 64=Decklock Extend/Retract Fault, 65=South Decklock Contactor Energized but Not Pulling In, 66=North Decklock Contactor Energized but Not Pulling In, and 67=Cable Reel Contactor Energized but Not Pulling In.

In an example embodiment, selecting input 1260 clears the VLC error. Selecting input 1262 clears the deck error. In an example embodiment, selecting input 1264 clears an error received from a servo control module (in this example a Pac Motion Module or “PMM” available from Emerson Electric Co.). Selecting input 1262 will reset the drive.

In an example embodiment, selecting input 1268 causes the controller 302 to send a signal to VLC 110 to extend the first (e.g., Northwest) deck lock. Selecting input 1270 causes the controller 302 to send a signal to VLC 110 to extend the second (e.g., Northeast) deck lock. Selecting input 1262 causes the controller 302 to send a signal to VLC 110 to extend the third (e.g., Southwest) deck lock. Selecting input 1274 causes the controller 302 to send a signal to VLC 110 to extend the fourth (e.g., southwest) deck lock.

In an example embodiment, switches 1280, 1282 are employed to select the operating mode. In an example embodiment, Switch 1280 OFF and switch 1282 MAN is a manual mode of operation (operator inputs, at least one safety interlock bypassed), switch 1280 OFF and switch 1282 AUTO is a first auto operating mode (operator inputs, safety interlocks engaged), and switch 1280 ON and switch 1282 AUTO is a second auto mode, or autonomous mode (computer inputs and safety interlocks on).

In an example embodiment, if an error or fault is detected, an error code is displayed at one of the areas represented by 1290, 1292, 1294, 1296. Examples of error codes that can displayed at 1290, 1292, 1294, 1296 include but are not limited to 17=Stall Fault—The Deck Has Not Moved For Too Long, 26=Drive Fault, 33=Decklocks Did Not Retract, 34=Decklocks Did Not Extend, 35=Did Not Complete Set Down Move, 42=Did Not Get Chain Slack When Landed, 70=Destination Floor is Higher Than Allowed, 71=Destination Floor is Lower Than Allowed, 74=Position is Not Valid (e.g., the position obtained from the Digital Signal Module “DSM” available from Emerson Electric Co. although any suitable module can be employed), 81=Deck Not In Auto, 83=Communication from Deck Down, 85=EGD Communication with Deck Down, and 865=REM Present In Deck When Move Command Issued.

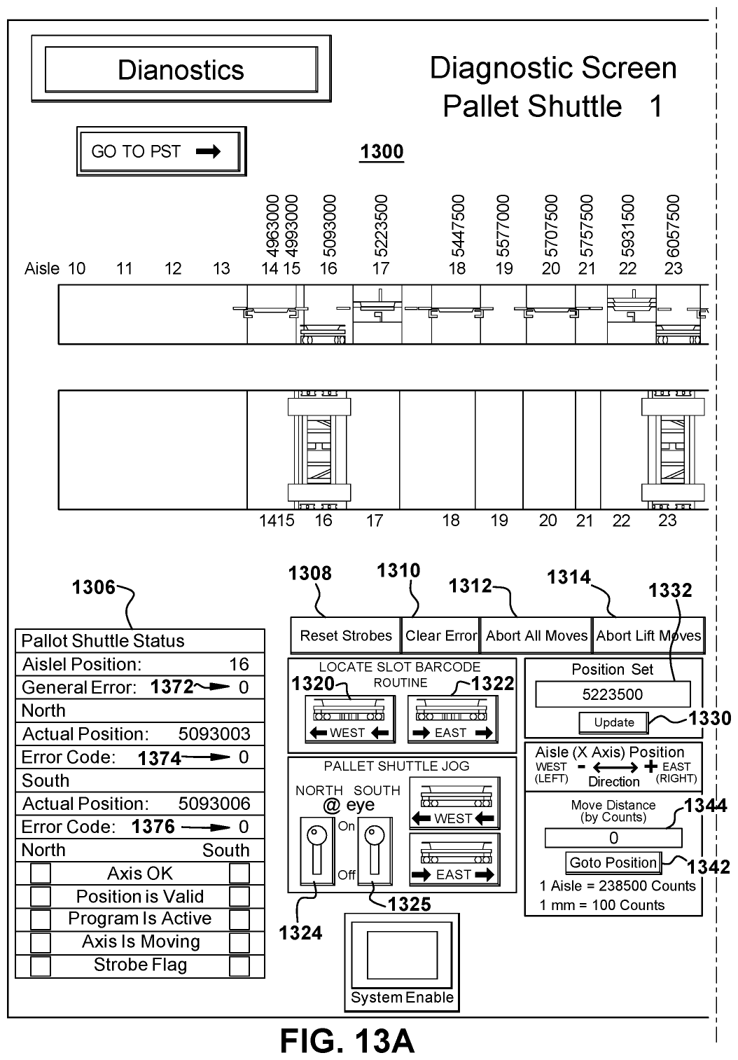

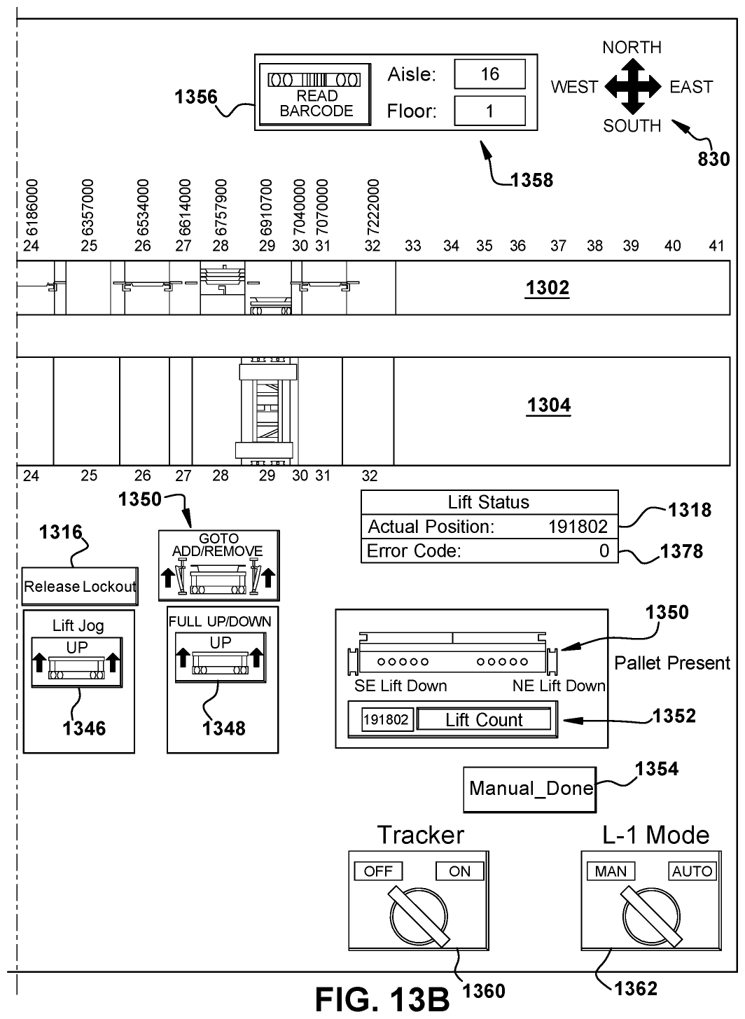

FIG. 13 illustrates an example diagnostic screen for a Pallet Shuttle (PS) that can be employed by user interface 404 to allow an operator to interact with the components of the Pallet Shuttle. Screen 1300 provides the status of the components of an Pallet Shuttle and if there is a malfunction, what component of the Pallet Shuttle or what sensor is not working or causing a problem. Additionally, as will be described below, the operator can manually control the Pallet Shuttle by interacting with diagnostic screen 1300.

In an example embodiment, a graphical representation of aisle is represented by 1302 which illustrates the locations of entry exit stations (EES), Pallet Stackers (PS)/Packet Vertical Lifts (PVT), and whether a pallet is present in an EES. At 1304 there is represented a graphical representation of the real time position of Pallet Shuttles (PS) in the garage.

In an example embodiment, the status of the pallet shuttle is represented at 1306. The status date data includes, but is not limited to position data and if any errors or faults are detected, a code associated with the detective error or fault.

In an example embodiment, input 1308 is employed to reset the strobes, which clears the last position search. Input 1310 is employed to clear an error. Input 1312 is employed to cause the controller 302 to send a signal to abort all movements of the pallet shuttle. Input 1314 is employed to cause the controller 302 to send a to abort lift moves of the pallet shuttle. Input 1316 is employed to cause the controller 302 to send a signal to release a lockout of the pallet shuttle.

In an example embodiment, input 1320 is employed to cause the controller 302 to send a signal to locate a slot/barcode to the West of the current pallet position. Input 1322 is employed to cause the controller 302 to send a signal to locate a slot/barcode to the East of current pallet position.

In an example embodiment, icon 1324 is employed to provide a graphical representation of whether a strobe on a first (e.g., North) side of the pallet shuttle is detected (ON=detected, Off=strobes not detected). Icon 1325, is employed to provide a graphical representation of whether a strobe on a second (e.g., South) side of the pallet shuttle is detected (ON=detected, Off=strobes not detected). The input at 1330 is employed to update the position of the shuttle to the position indicated at 1332. The position of the pallet shuttle is moved by inputting a distance (or count, e.g., 1 count=1 mm) in 1340, where to move in a first direction (e.g., left or West) a negative number in input, and to move in a second direction (e.g., right or East a positive number is input. Input 1342 is employed to cause the controller 302 to send a signal to the REM to move the pallet shuttle a predefined distance (counts) specified at 1344. The input at 1346 causes a lift to move a predefined distance (jog) up. In input at 1348 is employed to cause the controller 302 to send a signal to the REM to move the lift into the Full up position. The input at 1350 is employed to enable an operator to manually add or remove a pallet and a specified location.

In an example embodiment, the lift status is specified. The position of the lift is specified at 1318. If an error is detected with the lift, an error code is displayed at 1378. Examples of lift error codes and their definitions include but are not limited to 74=Position Not Valid for Lift Axis and 75=Not In Auto When Lift Command Given.

In an example embodiment, status of the first (e.g., SE) Lift and a second (e.g., NE) Lift are displayed at 1350. The lift count is displayed at 1352.

In an example embodiment, selecting the input at 1354 causes all the bits in the program which were set for manual Operations to reset and the Machine can be switched to Auto mode. Although the software takes care of resetting the bits, this is an extra safety feature provided to the operator.

In an example embodiment, input 1356 causes the pallet shuttle's barcode reader to read a barcode. The aisle and floor provided by the barcode that was read by the barcode reader are displayed at 1358.

In an example embodiment, error codes for errors detected with the pallet shuttle are displayed at locations 1372, 1374, 1376. Examples of error codes and their definitions include, but are not limited to 1=One Axis is Still Moving After (Other Axis Has Stopped, 2=System Not Enabled, 3=Collision Detected, 13=MCR Main Control Relay, provides power to Motor Amplifiers) Not On, 14=South Amp Contactor (where a Contractor is a Unit which controls power supplied to Amplifiers (Amps) of Motors located in the declared direction.) Not On, 15=East Amp Contactor Not On, 16=West Amp Contactor Not On, 17=North Amp Contactor Not On, 30=Move Done With South Strobe Not Seen, 31=Move Done With North Strobe Not Seen, 40=Dropped Pallet Laser Sensor Broken After Get or Put, 47=Barcode Read Doesn't Match Commanded Aisle to Move to, 48=Move Completed but Barcode Not Read, 49=Commanded Aisle To Go To Overlaps with Deckmate, 50=Window Overlaps with Deckmate's Window, 51=Windows Overlap. 88=The Machine the Shuttle is Locking out Doesn't Match it's Floor and Row, 89=The Machine About to Be Locked Out Doesn't Match the Type it Should Be, 90=EGD Problem, 102=West Collision Sensor Not On When Next to Wall or Deckmate, 103=East Collision Sensor Not On When Next to Wall or Deckmate, 104=EGD to West Deckmate Down, and 105=EGD to East Deckmate Down.

In an example embodiment, switches 1360, 1362 are employed to select the operating mode. In an example embodiment, Switch 1360 OFF and switch 1362 MAN is a manual mode of operation (operator inputs, at least one safety interlock bypassed), switch 1360 OFF and switch 1362 AUTO is a first auto operating mode (operator inputs, safety interlocks engaged), and switch 1360 ON and switch 1362 AUTO is a second auto mode, or autonomous mode (computer inputs and safety interlocks on).

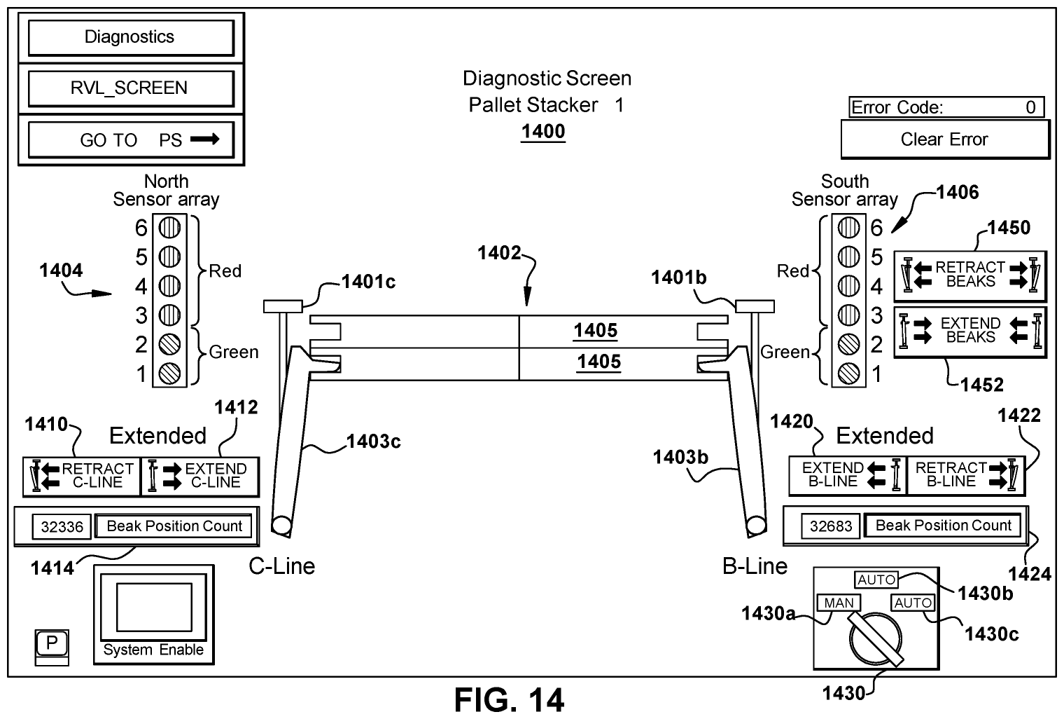

FIG. 14 illustrates an example diagnostic screen 1400 for a Pallet Stacker (PST) that can be employed by user interface 404 to allow an operator to interact with the components of the Pallet Stacker. Screen 1400 provides the status of the components of an Pallet Stacker and if there is a malfunction, what component of the Pallet Stacker or what sensor is not working or causing a problem. Additionally, as will be described below, the operator can manually control the Pallet Stacker by interacting with diagnostic screen 1400.

In an example embodiment, the screen comprises a graphical representation of the pallet stacker as represented by 1402. The graphical representation comprises the positions of Garage representation lines. In the illustrated example, the A line is the Entry or starting of Garage, the B-Line is starting of the entry-exit station, the C-Line is the end of entry-exit station and the beginning of the Aisle, and the D-line is the end of the Aisle and the beginning of VLC the and so on.

In the illustrated example a position of a first (B-Line) pallet support mechanism and second pallet support mechanism are illustrated by 1401C and 1401B respectively. Beaks associated with the pallet supports mechanisms 1401, 1401B are illustrated by 1403c and 1403B respectively. The position of the pallet support mechanism represented by 1401C is controlled by inputs 1410 and 1412. Input 1410 moves the pallet support mechanism represented by 1401C in a first direction (“Retract”) and input 1412 moves the pallet support mechanism represented by 1401C in a second direction (“Extend”). The position of the pallet support mechanism represented by 1401B is controlled by inputs 1420 and 1422. Input 1420 moves the pallet support mechanism represented by 1401B in a first direction (“Extend”) and input 1422 moves the pallet support mechanism represented by 1401B 1401B in a second direction (“Extend”). A visual representation of the beaks associated with the pallet support mechanisms are represented by 1403C and 1403C. Input 1450 retracts the beaks represented by 1403C, 1403B and input 1452 extends the beaks represented by 1403C, 1403B. A visual representation of the pallets on the pallet stack are provided by 1405.

In an example embodiment, pallets detected by a first side (e.g., North) sensor array is indicated at 1404. A first color (e.g., green) is employed to indicate the presence of a pallet and a second color (e.g., red) is employed to indicate the absence of a pallet. A visual representation of pallets detected by a second (e.g., South) sensor array is indicated at 1406. A first color (e.g., green) is employed to indicate the presence of a pallet and a second color (e.g., red) is employed to indicate the absence of a pallet.

In an example embodiment, the switch 1430, allows the operator to control how the mode of operation of the pallet stacker. For example, in manual mode 1430a, the operator manually operates the pallet stacker. In auto mode 1430b, the controller 302 operates pallet stacker 1070b for a first automatic operation mode (inputs from operator), and position 1070c (for a second automatic operation mode (inputs from computer, e.g., autonomous).

In an example embodiment, if an error is detected, a code the error is displayed at 1440. Examples of error codes and their definitions include, but are not limited to 51=The Pallet Shuttle is Requesting a Put with the Stacker Full, 52=The Pallet Shuttle is Requesting a Get with No Pallets in the Stacker, 54=The Beaks Have Taken Too Long to Extend or Retract, 61=A Request for An Interlock is Being Made, but the Stacker is in Manual Mode, 62=A Request for An Interlock is Being Made, but the Stacker is Locked by the PVL, and 88=A Pallet Shuttle is Requesting an Interlock, But the Floor and Row Don't Match, Input 1442 is employed to clear the error code. A visual representation of a rack position count is provided by 1414.

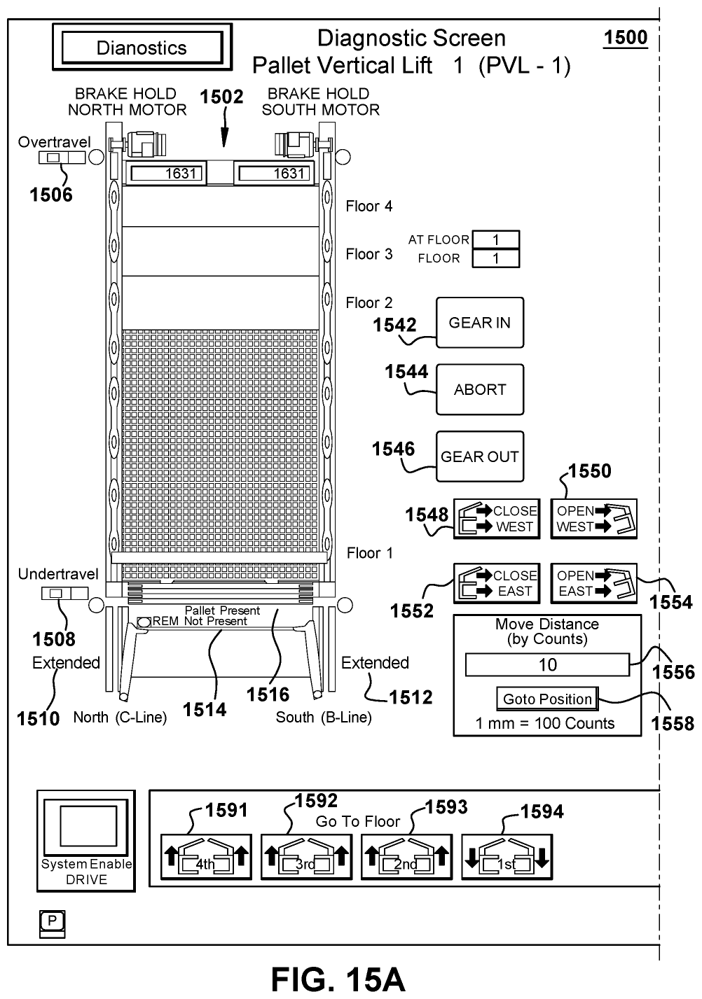

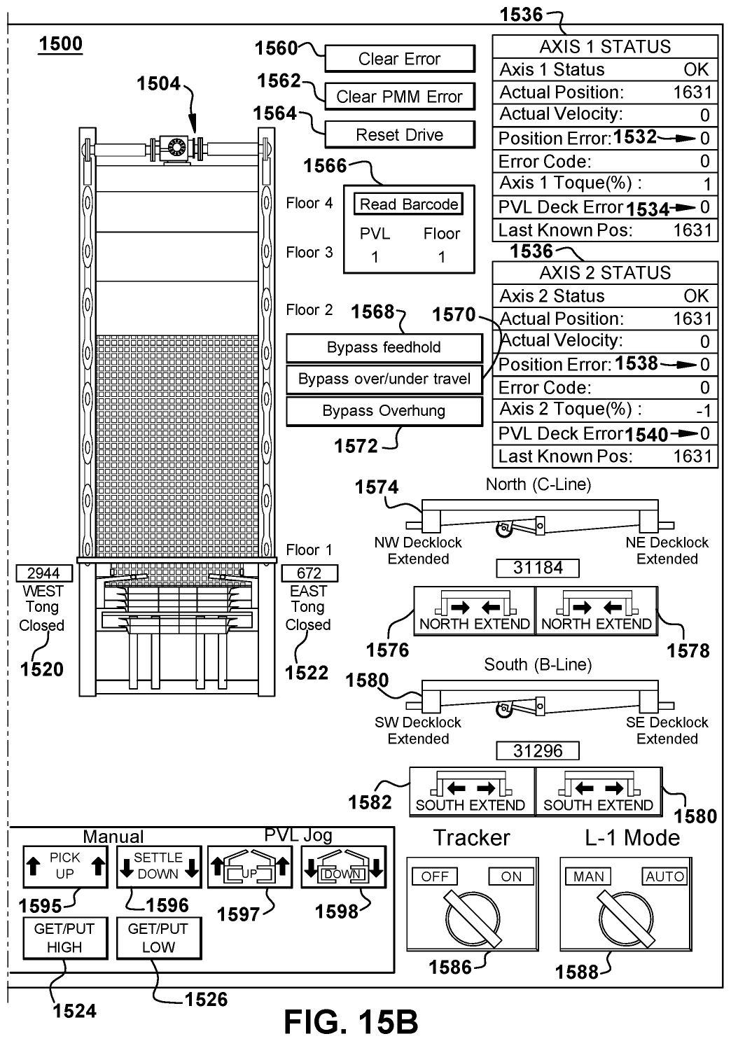

FIG. 15 illustrates an example diagnostic screen 1500 for a Pallet Vertical Lift (PVL) that can be employed by user interface 404 to allow an operator to interact with the components of the Pallet Vertical Lift. Screen 1500 provides the status of the components of an Pallet Vertical Lift and if there is a malfunction, what component of the Pallet Vertical Lift or what sensor is not working or causing a problem. Additionally, as will be described below, the operator can manually control the Pallet Shuttle by interacting with diagnostic screen 1500.

A graphical representation of the PVL viewed from a first direction (West in the illustrated example) is represented by 1502. A graphical representation of the PVL viewed from a second direction (South in the illustrated example) is represented by 1504.

In an example embodiment, the graphical representation 1502 provides a graphical indication of the location of the PVL (Floor 1), and whether an overtravel (exceeding the limit of travel for the PVL in the first or ‘up’ direction) was detected represented by 1506, and/or whether an undertravel (e.g., exceeding the limit of travel in a second or downward direction) was detected is represented by 1508. In particular embodiments, the graphical representation 1502 further provides whether the beaks of a pallet stacker below the PVL are extended. The status of the beak on the first (e.g, North) side is represented by 1510 and the status of the second (e.g., South) side is represented by 1512. In an example embodiment, the graphical representation further provides an indication of whether a REM is present at the pallet stacker at 1514 and whether a pallet is present on the pallet stacker represented at 1516.

In an example embodiment, the graphical representation 1504 provides an indication of the status of the Pallet Vertical Lift's tongs. The status of a first (e.g., West in this example) tong is represented by 1520 and the status of a second (e.g., East in this example) tong is represented by 1522.

In an example embodiment, the status of a first axis (Axis 1) is represented by 1530. Status information includes the position, velocity, position error, and if an error is detected for the PVL an error code at 1532 and if a PVL deck error is detected an error code at 1534.

In an example embodiment, if an error on the first axis is detected, a code the error is displayed at 1532. Examples of PVL error codes include, but are not limited to 26=Drive Not Ready, 27=Overtravel Detected, 28=Under travel Detected, 29=Chain Broken Detected, 30=Chain Slack Detected When Deck locks Retracted, 31=Tongs Have Not Closed Completely in Time Allotted, 32=Tongs Have Not Opened Completely in Time Allotted, 33=Deck locks Did Not Retract in Deck, 34=Deck locks Did Not Extend in Deck, 35=Stacker Beaks Did Not Retract, 36=There is a Fault in the Stacker with the Beaks, 37=Pallet Not Present on Deck When Beaks Told to Retract or PVL Ready to Lift After Get, 38=Dropped Pallet Laser Sensor Blocked When Beaks Told to Retract or PVL Ready to Lift After Get, 39=Pallet Present Prox Still On After Pallets Put in Stacker, 40=Dropped Pallet Laser Sensor Blocked When Opening Tongs, 41=Quantity of Pallet Present Sensors on Stacker North and South Side are not the Same, 42=Landed Position Not OK When Chain Slack Detected, 43=Get Requested by REM With No Pallet Present on Deck, 44=Put Requested by REM With A Pallet Present on Deck, 45=Put Requested by REM With Car Detection Laser Sensor Blocked, 52=Get Command Given with No Pallets in Stacker, 53=Put Command Given with Pallets in Stacker, 54=Put Command Given with No Pallets in the Deck, 56=Get Command Given with Pallets Already Present on Deck, 70=Destination Floor is More Than the Maximum Floor, 71=Destination Floor is Less Than the Minimum Floor, 72=Destination Floor is the Same as the Floor it's at, 73=Deck Should Be Landed but Chain Slack Not Being Seen, 74=Position is Not Valid, 75=The Selector Switch at the Stacker is Not in Auto When the PVL is in Auto, 76=Stall Fault—The Deck Has Not Moved For Too Long, 77=Jogging Up With Tongs Not Closed, 78=Jogging Up With Deck locks Not Retracted, 79=Get Command Given with Beaks Not Extended, 80=PVL Deck Moving Down with Beaks Not Retracted, 81=The PVL Deck is Not In Auto Ready Mode, 82=There Are Faults in the Stacker when PVL Told to Move, 83=There Are Faults in the Deck when PVL Told to Move, 84=EGD Down to Stacker when PVL Told to Move, 85=EGD Down to Deck when PVL Told to Move, 86=EGD Not OK in Stacker when PVL Told to Move, 87=REM Present when PVL Told to Move, 88=Jogging Down With Tongs Not Open, and 100=Get or Put Operation Has Taken Too Long to Complete.

In an example embodiment, if a deck error is detected, a code for the error is displayed at 1534. Examples of deck error codes include, but are not limited to 10=The Deck locks Have Taken Too Long to Extend or Retract and 20=The Tongs Have Taken Too Long to Extend or Retract.

In an example embodiment, the status of a second axis (Axis 2) is represented by 1536. Status information includes the position, velocity, position error, and if an error is detected for the PVL an error code at 1538 and if a PVL deck error is detected an error code at 1540.

In an example embodiment, if an error is detected for the second axis, a code the error is displayed at 1538. Examples of PVL error codes include, but are not limited to 26=Drive Not Ready, 27=Overtravel Detected, 28=Under travel Detected, 29=Chain Broken Detected, 30=Chain Slack Detected When Deck locks Retracted, 31=Tongs Have Not Closed Completely in Time Allotted, 32=Tongs Have Not Opened Completely in Time Allotted, 33=Deck locks Did Not Retract in Deck, 34=Deck locks Did Not Extend in Deck, 35=Stacker Beaks Did Not Retract, 36=There is a Fault in the Stacker with the Beaks, 37=Pallet Not Present on Deck When Beaks Told to Retract or PVL Ready to Lift After Get, 38=Dropped Pallet Laser Sensor Blocked When Beaks Told to Retract or PVL Ready to Lift After Get, 39=Pallet Present Prox Still On After Pallets Put in Stacker, 40=Dropped Pallet Laser Sensor Blocked When Opening Tongs, 41=Quantity of Pallet Present Sensors on Stacker North and South Side are not the Same, 42=Landed Position Not OK When Chain Slack Detected, 43=Get Requested by REM With No Pallet Present on Deck, 44=Put Requested by REM With A Pallet Present on Deck, 45=Put Requested by REM With Car Detection Laser Sensor Blocked, 52=Get Command Given with No Pallets in Stacker, 53=Put Command Given with Pallets in Stacker, 54=Put Command Given with No Pallets in the Deck, 56=Get Command Given with Pallets Already Present on Deck, 70=Destination Floor is More Than the Maximum Floor, 71=Destination Floor is Less Than the Minimum Floor, 72=Destination Floor is the Same as the Floor it's at, 73=Deck Should Be Landed but Chain Slack Not Being Seen, 74=Position is Not Valid, 75=The Selector Switch at the Stacker is Not in Auto When the PVL is in Auto, 76=Stall Fault—The Deck Has Not Moved For Too Long, 77=Jogging Up With Tongs Not Closed, 78=Jogging Up With Deck locks Not Retracted, 79=Get Command Given with Beaks Not Extended, 80=PVL Deck Moving Down with Beaks Not Retracted, 81=The PVL Deck is Not In Auto Ready Mode, 82=There Are Faults in the Stacker when PVL Told to Move, 83=There Are Faults in the Deck when PVL Told to Move, 84=EGD Down to Stacker when PVL Told to Move, 85=EGD Down to Deck when PVL Told to Move, 86=EGD Not OK in Stacker when PVL Told to Move, 87=REM Present when PVL Told to Move, 88=Jogging Down With Tongs Not Open, and 100=Get or Put Operation Has Taken Too Long to Complete.

In an example embodiment, if a deck error for the second axis is detected, a code for the error is displayed at 1540. Examples of deck error codes include, but are not limited to 10=The Deck locks Have Taken Too Long to Extend or Retract and 20=The Tongs Have Taken Too Long to Extend or Retract.

In an example embodiment, the input at 1542 (GEAR IN) to cause the controller 302 to send a signal to the PVL to move the gear in which synchs the motors. In an example embodiment, the input at 1544 (ABORT), causes the controller 302 to send a signal to the PVL to abort which would stop the motion or last command. In an example embodiment, the input at 1546 (GEAR OUT) causes the motors to move unsynchronized.

In an example embodiment, the input at 1548 causes the controller 302 to send a signal to the PVL to close the first tongs. the input at 1550 causes the controller 302 to send a signal to the PVL to the first tongs to open. The input at 1552 causes the controller 302 to send a signal to the PVL to close the second tongs. The input at 1554 causes the controller 302 to send a signal to the PVL to the second tongs to open.

In an example embodiment, the PVL can be caused to move to a predefined position represented by 1556 by selecting the input represented by 1558.

In an example embodiment, the input represented by 1560 is employed to clear any error codes listed under the first axis status 1530 and/or the second axis status 1532. The input represented by 1562 is employed to clear an error returned by a servo controller (e.g., a PMM error). The input represented by 1564 is employed to clear an error in the Drive Memory (Reset the Drive).

In an example embodiment, barcode stickers are located in each Aisle for horizontal moving machines or at Floors for Vertical moving machines. A barcode reader installed on the machine can read a barcode sticker and determine its location. The input represented by 1566 is employed to cause the controller 302 to send a signal to the PVL barcode reader to read a barcode. Upon reading the barcode, the PVL number and Floor to be displayed.

In an example embodiment, the PVL is prevented from moving down past a certain position when Tongs are not opened, referred to as a Feed hold. The input represented by 1568 is employed to cause the controller 302 to send a signal to the PVL to bypass the Feed hold.

In an example embodiment, the input represented by 1570 is employed to cause the controller 302 to send a signal to the PVL to bypass over/under travel (e.g., ignore over and/or under limits). As those skilled in the art can readily appreciate, this input may be provided in a manual mode when testing the PVL.

In an example embodiment, input 1572 is employed to cause the controller 302 to send a signal to the PVL to bypass overhung. For example, ignore overhung limits. As those skilled in the art can readily appreciate, this input may be provided in a manual mode when testing the PVL.

In an example embodiment, the status of the two of the deck locks on a first side (e.g., Northeast, Northwest) of the PVL is represented by 1574. The input 1576 is employed to cause the controller 302 to send a signal to the PVL to extend the deck locks (e.g., lock the deck at its current position). The input 1578 is employed to cause the controller 302 to send a signal to the PVL retract the deck locks (e.g., allow the deck to move).

In an example embodiment, the status of the two of the deck locks on a second side (e.g., Southeast, Southwest) of the PVL is represented by 1580. The input 1582 is employed to cause the controller 302 to send a signal to the PVL extend the deck locks (e.g., lock the deck at its current position). The input 1584 is employed cause the controller 302 to send a signal to the PVL to retract the deck locks (e.g., allow the deck to move).

In an example embodiment, switches 1582, 1584 are employed to select the operating mode. In an example embodiment, Switch 1582 OFF and switch 1584 MAN is a manual mode of operation (operator inputs, at least one safety interlock bypassed), switch 1582 OFF and switch 1584 AUTO is a first auto operating mode (operator inputs, safety interlocks engaged), and switch 1582 ON and switch 1584 AUTO is a second auto mode, or autonomous mode (computer inputs and safety interlocks on).

In an example embodiment, inputs 1591, 1592, 1593, 1594 are employed to cause the controller 302 to send a signal to the PVL to move the PVL to a specified floor. Input 1591 causes the controller to move the PVL to the fourth floor. Input 1592 causes the controller to move the PVL to the third floor. Input 1593 causes the controller to move the PVL to the second floor. Input 1594 causes the controller to move the PVL to the first floor.

In an example embodiment, input 1595 causes the controller 302 to send a signal to the PVL to cause a predefined (small) move from the landing position to the hanging position (or pick up. input 1596 causes the controller 302 to send a signal to the PVL to cause the PVL to move a predefined (e.g., small) distance from a hanging position to the landing position (or settle down).

In an example embodiment, input 1597 causes the controller to send a signal to the PVL to cause the PVL to move a predefined distance (jog) in the upward direction. The input 1598 causes the controller to send a signal to the PVL to cause the PVL to move a predefined distance (jog) in the downward direction.

In an example embodiment, the input 1524 (Get/Put High) causes the controller 302 to send a signal to cause the PVL to move to the highest position while getting or putting pallet bundles in a PST. The input 1526 (Get/Put Low) causes the controller 302 to send a signal to the PVL to cause the PVL to move to the lowest position while getting or putting a pallet bundle.

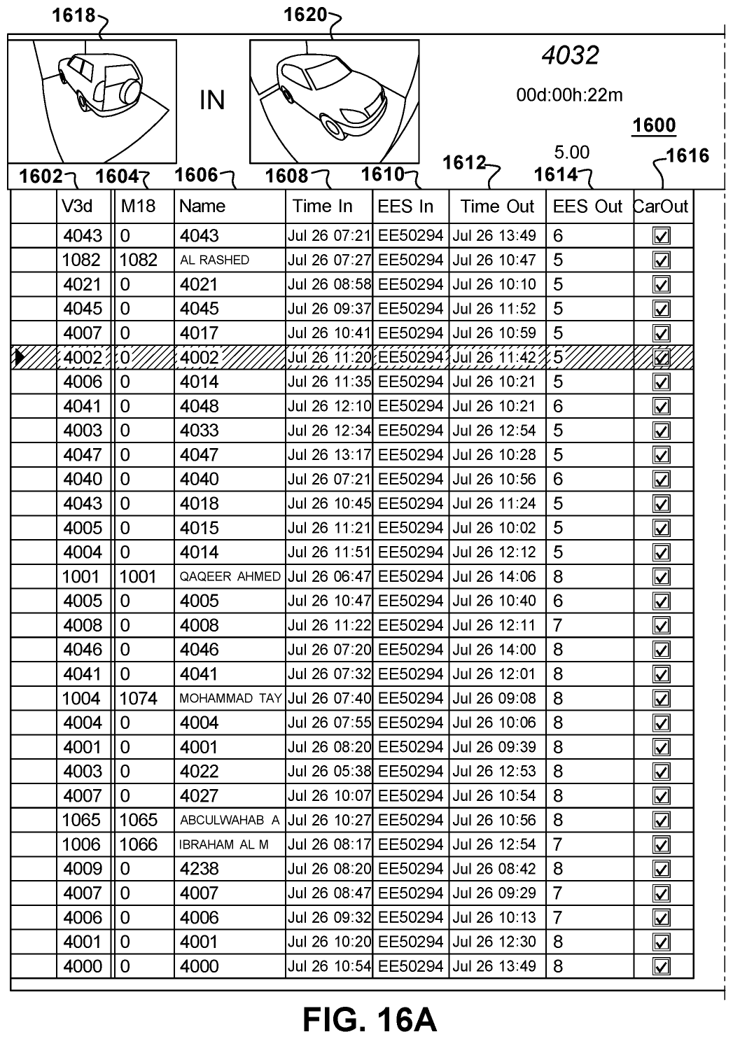

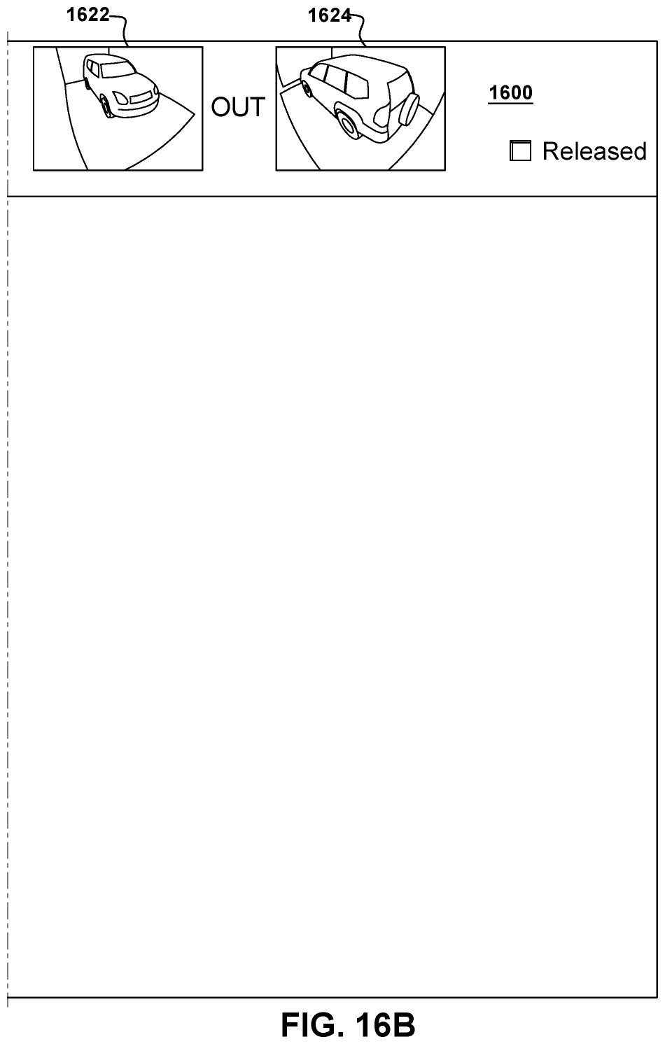

FIG. 16 illustrates an example of an operator interface 1600 to view the status of vehicles that were parked in the parking garage. As will be described herein, this includes whether the vehicle has exited the parking garage, and if so, when.

Column 1602 displays the _VM. Column 1604 displays a _ for the vehicle. Column 1606 displays a name, if known (e.g., a registered customer), or an assigned transaction number which matches the number in column 1602. Column 1608 displays the time the vehicle was parked in the parking garage 100 and column 1610 displays the entry exit station 118 where the arrived.

If the vehicle has been retrieved, column 1612 displays the time the vehicle left the parking garage 100 and the entry exit station 118 where the vehicle departed. Column 1616 indicates whether the vehicle has left.

In an example embodiment, two views of the vehicle when the vehicle arrived are displayed at 1618, 1620. The views at 1618, 1620 are associated with a particular transaction and time stamped. If the vehicle is departed, two views of the vehicle when the vehicle departed are displayed at 1622, 1624. The views at 1622, 1624 are time stamped. These views 1618, 1620, 1622, 1624 provide proof of the condition of the vehicle and if there was any damage when the vehicle arrived and when the vehicle departed in case there is a dispute or claim of damage to the vehicle while it was parked in the robotic parking garage 100.

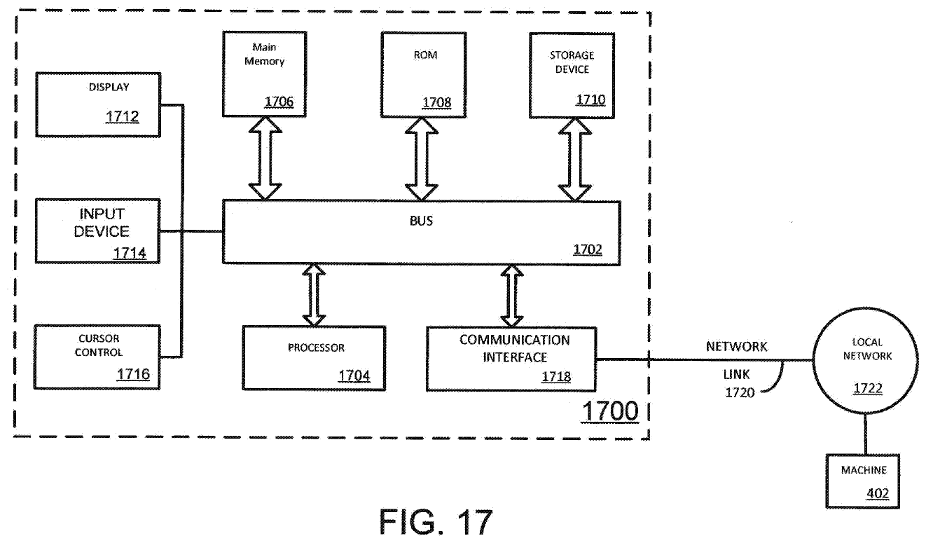

FIG. 17 is a block diagram that illustrates a computer system 1700 upon which an example embodiment may be implemented. For example, computer system 1700 can be employed by controller 302 to implement the logic 304 for performing the functionality described herein.

Computer system 1700 includes a bus 1702 or other communication mechanism for communicating information and a processor 1704 coupled with bus 1702 for processing information. Computer system 1700 also includes a main memory 1706, such as random-access memory (RAM) or other dynamic storage device coupled to bus 1702 for storing information and instructions to be executed by processor 1704. Main memory 1706 also may be used for storing a temporary variable or other intermediate information during execution of instructions to be executed by processor 1704. Computer system 1700 further includes a read only memory (ROM) 1708 or other static storage device coupled to bus 1702 for storing static information and instructions for processor 1704. A storage device 1710, such as a magnetic disk or optical disk, is provided and coupled to bus 1702 for storing information and instructions.

Computer system 1700 may be coupled via bus 1702 to a user interface that comprises a display 1712, an input device 1714, and a cursor control 1716. The display 1712 can be any suitable type of device for displaying information such as a cathode ray tube (CRT), liquid crystal display (LCD), or light emitting diode (LED) for displaying information to a computer user. An input device 1714, such as a keyboard including alphanumeric and other keys is coupled to bus 1702 for communicating information and command selections to processor 1704. Another type of user input device is cursor control 1716, such as a mouse, a trackball, or cursor direction keys for communicating direction information and command selections to processor 1704 and for controlling cursor movement on display 1712. This inputs device typically has two degrees of freedom in two axes, a first axis (e.g., x) and a second axis (e.g., y) that allows the device to specify positions in a plane. In an example embodiment, the input device 1714 is a touch screen. In an example embodiment, the user interface comprises a touch screen which can include the functionality of the input device 1714 and/or cursor control 1716.

An aspect of an example embodiment is related to the use of computer system 1700 for implementing an information system for a robotic parking garage. According to one embodiment, implementing an information system for a robotic parking garage is provided by computer system 1700 in response to processor 1704 executing one or more sequences of one or more instructions contained in main memory 1706. Such instructions may be read into main memory 1706 from another computer-readable medium, such as storage device 1710. Execution of the sequence of instructions contained in main memory 1706 causes processor 1704 to perform the process steps described herein. One or more processors in a multi-processing arrangement may also be employed to execute the sequences of instructions contained in main memory 1706. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 704 for execution. Such a medium may take many forms, including but not limited to non-volatile media. Non-volatile media include for example optical or magnetic disks, such as storage device 710. Common forms of computer-readable media include for example RAM, PROM, EPROM, FLASHPROM, CD, DVD, SSD or any other memory chip or cartridge, or other medium from which a computer can read.

Computer system 1700 also includes a communication interface 1718 coupled to bus 1702. Communication interface 1718 provides a two-way data communication coupling to a network link 1720 that is connected to a local network 1722. For example, communication interface 1718 may be an integrated services digital network (ISDN) card or a modem to provide a data communication connection to a corresponding type of telephone line. As another example, communication interface 1718 may be a local area network (LAN) card to provide a data communication connection to a compatible LAN. Wireless links may also be implemented. In any such implementation, communication interface 1718 sends and receives electrical, electromagnetic, or optical signals that carry digital data streams representing various types of information.

Network link 1720 typically provides data communication through one or more networks to another machine 402. For example, network link 1720 may provide a connection through local network 1722 to a machine 402 in the robotic parking garage 100. In an example embodiment, the local network 1722 provides data communications through the worldwide packet data communication network, now commonly referred to as the “Internet”. Local networks 1722 and Internet both use electrical, electromagnetic, or optical signals that carry the digital data to and from computer system 1700, are exemplary forms of carrier waves transporting the information.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
a user interface that comprises a display and an input, the user interface is coupled with a controller that is coupled with a machine associated with an operation of an automated parking garage that comprises a motor, the machine is selected from a group consisting of an entry level carrier module, a horizontal carrier module, a rack entry module, a pallet shuttle, a pallet stacker, a pallet vertical lift, and a vertical lift carrier;
the user interface operable to obtain from a sensor coupled with the motor and the controller, data representative of a movement of the motor and provide the data representative of the movement of the motor to the controller; and
the user interface is operable to display a runtime value selected from a group consisting of a number of rotations of the motor, an amount of time the motor has been operating, a number of rotations of a turntable associated with the motor, an amount of time a cable reel associated with the motor has been operating, and a number of times a rack entry module has moved up and down;
the user interface is further operable to display a threshold value corresponding to the runtime value; and
the user interface is operable to receive a change via the input to the threshold value and automatically update the threshold value.

2. The apparatus set forth in claim 1, the user interface is further operable to display values selected from a group consisting of a number of revolution of the motor, an amount of time the motor has been operating, a number of revolutions of a turntable associated with the motor, an amount of time a cable reel associated with the motor has been operating, and a number of times a rack entry module has moved up and down that do not exceed their threshold in a first color and a value that exceeds and another value selected from a group consisting of a number of revolution of the motor, an amount of time the motor has been operating, a number of revolutions of a turntable associated with the motor, an amount of time a cable reel associated with the motor has been operating, and a number of times a rack entry module has moved up and down that exceeds its threshold value in a second color.

3. The apparatus set forth in claim 1, further comprising an input to reset the selected runtime value selected from a group consisting of a number of rotations of the motor, an amount of time the motor has been operating, a number of revolutions of a turntable associated with the motor, an amount of time a cable reel associated with the motor has been operating, and a number of times a rack entry module has moved up and down.

4. The apparatus set forth in claim 1, further comprising:
a plurality a machine associated with an operation of an automated parking garage that comprises a motor, the plurality of machines includes an entry level carrier module, a horizontal carrier module, a rack entry module, a pallet shuttle, a pallet stacker, a pallet vertical lift, and a vertical lift carrier;
a machine selection input operable to select a selected machine from the plurality of values; and
a reset input operable to reset the runtime values of the selected machine.

5. An apparatus comprising:
a user interface comprising a display and an input coupled with a controller, the controller is coupled with an entry exit module, a rack entry module, an upper-level horizontal carrier module, a vertical lift carrier module, a pallet shuttle, a pallet stacker, and a pallet vertical lift;
the user interface includes but not limited to diagnostic screens for the entry exit module, the entry level carrier module, the rack entry module, the upper level horizontal carrier module, the vertical lift carrier module, the pallet shuttle, the pallet stacker, and the pallet vertical lift;
the user interface is operable to receive a diagnostic screen selection input from the user interface input and to select a diagnostic screen corresponding to a machine selected from the group consisting of the entry exit module, the entry level carrier module, the rack entry module, the upper level horizontal carrier module, the vertical lift carrier module, the pallet shuttle, the pallet stacker, and the pallet vertical lift; and
the user interface is operable to display a status of the machine corresponding to the selected diagnostic screen and when operating in a predefined mode selected from a plurality of operating modes, the controller is responsive to receiving an input from the selected diagnostic screen to cause the corresponding machine to move a predefined distance.

6. The apparatus set forth in claim 5, wherein the selected diagnostic screen is an entry exit diagnostic screen that corresponds to the entry exit module, the entry exit diagnostic screen comprising:
the input comprises a first input operable to cause a motor coupled to the inner door to switch the inner door between an open and closed position, wherein the status of the inner door is displayed;
the display further displays the status of the outer door of the entry exit module and the input comprises a second input cause a motor coupled with the outer door to switch the outer door between an open and closed position;
the display is further operable to output a status of tracks in the entry exit module;
the display is further operable to output whether a vehicle is present in the entry exit area, and the input comprises a third input further causes a vehicle to be moved out of the entry exit module;
the display is further operable to output whether the entry exit module is operating entry mode or exit mode, the input comprises a fourth input causes the entry exit station to switch between entry mode and exit mode;
the display further comprises an output that indicates a height of a vehicle and an output that indicates an orientation of a vehicle when a vehicle is present in the entry exit module; and
The display further comprises an output that indicates the overall maximum length, maximum width, maximum weight and maximum height.

7. The apparatus set forth in claim 5, wherein the selected diagnostic screen is an entry level carrier module, Carrier module with Turn Table (CM-TT), diagnostic screen that corresponds to the entry level carrier module, the entry level carrier module diagnostic screen comprising:
the display is operable to provide a graphical representation of a location of a vertical lift carrier and an entry exit station;
the display is further operable to provide a visual indication of a status of a cable reel;
the input comprises a first input for switching the cable reel on and off;
the input comprises a second input operable to cause the entry level carrier to move and locate a barcode;
the display is operable to provide data obtained from the barcode that provides data on aisle location and floor number;
the input comprises a third input operable to move the entry level carrier module a predefined distance;
the display is further operable to provide a visual indication of whether a rack entry module is present;
the display is further operable to provide a visual representation of coordinates for the entry level carrier;
the input comprises a fourth input to manually update the position of the entry level carrier;
the display further comprises a visual representation of the entry level carrier along an axis;
the input comprises a fifth input operable to cause the carrier to move along the axis a designated distance;
the display is further operable to provide location data representative of an aisle and row of the entry level carrier;
the input comprises a sixth input operable to cause the entry level carrier to a designated aisle;
the input comprises a seventh input operable to cause the entry level carrier to get a pallet;
the input comprises an eighth input operable to cause the entry level carrier to store a pallet;
the display is further operable to provide a visual indication of an orientation of a turntable associated with the entry level carrier;
the input comprises a ninth input operable to cause the turntable to rotate a predefined distance in a first direction;
the input comprises a tenth input operable to cause the turntable to rotate a predefined distance in a second direction;
the input comprises an eleventh input operable to cause the turntable to move to a predefined position;
the input comprises a twelfth input operable to clear an error code from the display;
the input comprises a thirteenth input operable to cause the display to display a rack entry module diagnostic screen; and
a reset strobe input that is operable to reset a plurality of strobes, and clears a last position search.

8. The apparatus set forth in claim 5, wherein the selected diagnostic screen is a rack entry module diagnostic screen that corresponds to the rack entry module, the rack entry module diagnostic screen comprising:
a first area that provides status data for the rack entry module, the status data comprises data representative of a position of the rack entry module, whether a pallet is present on the rack entry module, and data representative whether an error was detected;
a first input operable to update a position of the rack entry module;
a second input operable to cause the rack entry module to a specified distance;
a third input operable to clear an error message from the display;
a fourth input operable to cause the rack entry module to abort a move;
a fifth input operable to cause the rack entry module to abort a move of a carrier module associated with the rack entry module;
a second area that provides a graphical view of a real-time position of the rack entry module within the robotic parking garage;
a third area operable to display a position of a first and second corners of a lift of a lift of the rack entry module;
a sixth input operable to release a lockout;
a fourth area operable to display a position of third and fourth corners of the lifts of the rack entry module;
a seventh input operable to cause a lift to move to a specified position in a first direction;
an eighth input operable to cause the lift to move to a specified position in a second direction;
a fifth area that displays a total time for moving a vehicle selected form a group consisting of getting and putting the vehicle or pallet from a device adjacent from the rack entry module from a group consisting of a slot and a vertical lift carrier;
a sixth area that provides a visual indication of a status of a brake in a lift motor;
a ninth input that is operable to retrieve a carrier module diagnostic screen for the carrier module;
a tenth input that is operable to cause a search for a strobe on a first side of the rack entry module;
an eleventh input that is operable to cause a search for a strobe on a second side of the rack entry module;
a first homing input that is operable to cause the rack entry module to move to a first position on the carrier module;
a second homing input that is operable to cause the rack entry module to move to a second position on the carrier module;
a first jog input that is operable to cause the rack entry module to move a predefined distance in a first direction;
a second jog input that is operable to cause the rack entry module to move a predefined distance in a second direction;
a first switch input that is operable to cause a strobe light at a home position to selectively operate in one of a group consisting of an on and off position;
a second switch input that is operable to cause a strobe light associated with a row to selectively operate in one of a group consisting of an on and off position;
a mode switch that is operable to selectively operate the rack entry module in a mode selected from a manual, a first automatic mode that employs operator inputs, and a second automatic mode that employs computer inputs; and
a reset strobe input that is operable to reset a plurality of strobes, and clears a last position search.

9. The apparatus set forth in claim 5, wherein the selected diagnostic screen is an upper-level horizontal carrier diagnostic screen that corresponds to the upper-level horizontal carrier module, the upper-level horizontal carrier diagnostic screen comprising:
a visual representation of a first aisle and a second aisle adjacent to the upper-level horizontal carrier module;
a visual representation of a location of a vertical lift carrier located in an aisle selected from a group consisting of the first aisle and the second aisle;
a visual representation of a location of a pallet vertical lift located in an aisle selected from a group consisting of the first aisle and the second aisle;
a visual representation of a location of the upper-level horizontal carrier module with respect to the first aisle and the second aisle;
a visual representation of the upper-level horizontal carrier module's position;
a visual representation of whether an error condition was detected;
a graphical representation of a cable reel and a status of the cable reel;
a bar code read input operable to cause a bar code scanner associated with the upper-level horizontal carrier modules to read a bar code and a visual representation of an aisle and floor of a barcode read by the bar code scanner;
a visual representation of a position of a rack entry module;
a move commands section that provides data representative of the aisle and the floor where the upper level horizontal carrier modules is located, a first move command input that is operable to cause the upper level horizontal carrier modules to move to a particular aisle, a second move command input 1124 can be employed to cause the upper level horizontal carrier module to get a pallet, a third move command input that is operable to cause the upper level horizontal carrier module remove a pallet off of the upper level horizontal carrier module;
a clear error input that enables an operator to clear an error detected for the upper-level horizontal carrier module;
a reset strobe input operable to cause a reset a strobe light and clears a last position search;
a rack entry module abort input that is operable to cause upper-level horizontal carrier module to abort a rack entry module move;
an upper-level horizontal carrier module abort input operable to cause the upper level horizontal carrier module to abort a movement;
a change diagnostic screen input that is operable to cause the selected diagnostic screen to change to a remote entry module diagnostic screen;
at least one mode input operable to select an operating mode of the upper-level horizontal carrier module; and
a reset strobe input that is operable to reset a plurality of strobes, and clears a last position search.

10. The apparatus set forth in claim 5, wherein the selected diagnostic screen comprises a Vertical lift conveyor Drive diagnostic screen and a vertical lift conveyor deck diagnostic screen where the vertical lift conveyer deck moves from floor to floor, the diagnostic screen comprising:
a visual representation of a location of the vertical lift conveyor module and when an error is detected, an error code corresponding to the detected error;
a barcode read input operable to cause a barcode reader on the Vertical lift conveyor Deck to read a barcode and present a visual representation of machine number and a floor read by the barcode reader;
a graphical representation of the status of a brake on a first motor and a break on a second motor;
a move to floor input operable to obtain data representative of a specified floor and is operable to cause the vertical lift carrier module to move to the specified floor;
a pickup vertical lift conveyor deck input that is operable to cause the deck to move into an up position;
a settle down vertical lift conveyor deck input that is operable to cause the deck to move into a down position;
a move distance input operable to receive a data representative of a desired distance to move the vertical lift conveyor deck with data inputted;
an abort input operable to cause the vertical lift conveyor drive module to stop all movements of the vertical lift conveyor deck module;
a Vertical lift conveyor Drive gear out input causes the first and second motors to move individually without synchronization;
a Vertical lift conveyor Drive gear-in input to operate the first and second motors in synchronization a bypass over/under travel input operable to allow the vertical lift conveyor deck to move past an over limit position or an under-limit position;
a bypass overhang limit that is operable to allow the vertical lift conveyor deck to move past an overhang limit;
a jog up input operable to cause the vertical lift conveyor deck to move up a predefined jog speed;
a jog down input operable to cause the vertical lift conveyor deck to move down a predefined jog speed;
a deck locks extend input operable to cause a vertical lift conveyor deck's locks to extend;
a deck locks retract input operable to cause the vertical lift conveyor deck's locks to retract;
a visual representation of a vertical lift conveyor deck error code;
a clear Vertical lift conveyor Drive clears a lift error detected on the drive;
a vertical lift conveyor deck clear error input operable to clear a detected deck error;
a PMM error input operable to clear an error received from a servo control module associated with the Vertical lift conveyor Drive
a first deck lock extend input operable to cause a pair of first deck locks to extend;
a second deck locks extend input operable to cause a pair of second deck locks to extend;
a first deck locks retract input operable to cause the pair of first deck locks to retract; and
a second deck locks retract input operable to cause a pair of second deck locks to retract.

11. The apparatus set forth in claim 5, wherein the selected diagnostic screen is a pallet shuttle diagnostic screen that corresponds to the pallet shuttle, the pallet shuttle diagnostic screen comprising:
a visual representation of an aisle, which provides a location of an entry exit station, a pallet stacker, and a pallet vehicle lift, and whether a pallet is present in an entry exit station;
a visual representation of a real time position of the Pallet Shuttles;
a visual representation of a status of the pallet shuttle that comprises position data and data representative of a detected error, and a code associated with the detected error;
a reset strobe input that is operable to reset a plurality of strobes, and clears a last position search;
an abort pallet shuttle input operable to abort a pallet shuttle lift move;
a release lockout input operable to cause a Rack Entry Module to release a lockout of the pallet shuttle;
a clear error input operable to clear an error for the pallet shuttle;
an abort input operable to cause the pallet shuttle to stop;
a first locate slot input operable to cause the pallet shuttle to move in a first direction and locate a barcode;
a second barcode slot input operable to cause the pallet shuttle to move in a second direction to locate a barcode;
a visual representation that provides a graphical representation of whether a strobe is being detected in a first direction;
a visual representation that provides a graphical representation of whether a strobe is being detected in a second direction;
a first pallet shuttle jog input operable to cause the pallet shuttle to move a predefined distance in a first direction;
a second pallet shuttle jog input operable to cause the pallet shuttle to move a predefined distance in a second direction;
a position set update input operable to cause a position of the pallet shuttle to be updated;
a move distance input operable to move the pallet shuttle to a selected position;
an update position input operable to update the position of the pallet shuttle;
a move distance by counts input operable to receive a selected distance and a go to position input operable to move the pallet shuttle the selected distance;
a lift jog up input operable to cause a lift on the pallet shuttle to move a predefined distance in a first direction;
a lift full up down input operable to cause the lift on the pallet shuttle to move to a full up and full down position respectively;
an add/remove pallet input operable to cause a pallet shuttle lift to go to a position where a pallet is to be one of a group consisting of added to and removed from a pallet stacker;
a visual representation of an actual lift position and an error code for the lift;
a visual representation indicating whether a pallet is present;
a visual representation of a first lift position;
a visual representation of a second lift position; and
a visual representation of a number of times the lift has been raised and lowered.

12. The apparatus set forth in claim 5, wherein the selected diagnostic screen is a pallet stacker diagnostic screen that corresponds to the pallet stacker, the pallet stacker diagnostic screen comprising:
a visual representation of a position of a first and a second pallet support mechanisms;
a visual representation of a position first and second beaks associated with the first and second pallet support mechanisms;
a visual representation of how many pallets are on the pallet stacker;
a visual representation provided by a first sensor array of pallets detected on a first side of the pallet stacker;
a visual representation provided by a second sensor array of pallets detected on a second side of the pallet stacker;
a first retract pallet support mechanism input operable to cause the first pallet support mechanism to move in a first direction;
a first extend pallet support mechanism input operable to cause the first pallet support mechanism to move in a second direction;
a second retract pallet support mechanism input operable to cause the second pallet support mechanism to move in the second direction;
a second extend pallet support mechanism input operable to cause the second pallet support mechanism to move in the first direction;
a retract beaks input operable to cause the first and second beaks to move to a retracted position;
an extend beaks input operable to cause the first and second beaks to move to an extended position;
a visual representation of an error code;
a clear error input operable to clear an error associated with the error code; and
a visual representation of a rack position count.

13. The apparatus set forth in claim 5, wherein the selected diagnostic screen is a pallet vertical lift diagnostic screen that corresponds to the pallet vertical lift, the pallet vertical lift diagnostic screen comprising:
a visual representation of the pallet vertical lift for a first direction;
a visual representation of the pallet vertical lift for a second direction;
a visual representation of a floor where the pallet vertical lift is located;
a visual representation of whether an overtravel limit was exceeded;
a visual representation of whether an under-travel limit was exceeded;
a visual representation of a position of a plurality of beaks of a pallet stacker below the pallet vertical lift;
a visual representation of whether a beak on a first side of the pallet stacker are extended;
a visual representation of whether a beak on a second side of the pallet stacker are extended;
a visual representation indicating whether a rack entry module is present;
a visual representation of whether a pallet is present on the pallet stacker;
a visual representation of a status of a tong on a first side;
a visual representation of a status of a tong on a second side;
a visual representation of a status of a first axis that comprises a position, a velocity, a position error code, and a deck error code on the first axis;
a visual representation of a status of second first axis that comprises a position, a velocity, a position error code, and a deck error code on the second axis;
a gear in input operable to cause a plurality of pallet vertical lift drive motors to operate synchronized;
an abort input operable to cause the pallet vertical lift drive to stop moving;
a gear out input operable to cause the plurality of pallet vertical lift drive motors to operate unsynchronized;
a first close input operable to cause the tong on the first side to close;
a first open input operable to cause the tong on the first side to open;
a second close input operable to cause the tong on the second side to close;
a second open input operable to cause the tong on the second side to open;
a position input operable to receive data representative of a position and a go to position input operable to cause the pallet vertical lift deck to move the position that was input into the position input;
a clear error input operable to clear a detected error;
a clear PMM error input operable to reset a drive motor on pallet vertical lift drive;
a read barcode input operable to cause a barcode reader associated with a deck of pallet vertical lift to read a barcode and provide a visual representation of a pallet vertical lift number and floor of the barcode that was read;
a bypass feed hold input operable to allow the pallet vertical lift to exceed a feed hold limit;
a bypass over-under travel input operable to allow the pallet vertical lift deck to exceed an over travel limit and an under-travel limit;
a bypass overhang input operable to allow the pallet vertical lift to exceed an overhang limit;
a visual representation of a position of deck locks on a first side of the pallet vertical lift;
a visual representation of a position of deck locks on a second side of the pallet vertical lift;
an extend deck locks input operable to extend deck locks and lock the pallet vertical lift at a current position;
an retract deck locks input operable to retract deck locks and allow the pallet vertical lift to move;
a plurality of go to floor input operable to cause the pallet vertical lift to move to a designated floor;
a pick-up input operable to cause the pallet vertical lift to move to a hanging position;
a settle down input operable to cause the pallet vertical lift to move to a landing position;
a PVL jog up input operable to cause the pallet vertical lift to move the deck up with predefined job velocity;
a PVL jog down input operable to cause the pallet vertical lift to move down with predefined jog velocity;
a get put High input operable to cause the pallet vertical lift deck to move to a highest position in the pallet stacker while performing a get or put of pallet bundle; and
a get put low input operable to cause the pallet vertical lift deck to move to a lowest position in the pallet stacker while performing a get or put of pallet bundle.

14. An method, comprising:
providing a user interface comprising a display and an input coupled with a controller, the controller is coupled with an entry exit module, a rack entry module, an upper-level horizontal carrier module, a vertical lift carrier module, a pallet shuttle, a pallet stacker, and a pallet vertical lift, the user interface provides diagnostic screens for the entry exit module, the entry level carrier module, the rack entry module, the upper level horizontal carrier module, the vertical lift carrier module, the pallet shuttle, the pallet stacker, and the pallet vertical lift;
receiving a diagnostic screen selection input from the user interface input and selecting a diagnostic screen corresponding to a machine selected from the group consisting of the entry exit module, the entry level carrier module, the rack entry module, the upper level horizontal carrier module, the vertical lift carrier module, the pallet shuttle, the pallet stacker, and the pallet vertical lift; and
displaying a status of the machine corresponding to the selected diagnostic screen and when operating in a predefined mode selected from a plurality of operating modes, the controller is responsive to receiving an input from the selected diagnostic screen to cause the corresponding machine to move a predefined distance.

15. The method of claim 14, wherein the selected diagnostic screen is an entry exit diagnostic screen that corresponds to the entry exit module, the method further comprising:
receiving a first input operable to cause a motor coupled to the inner door to switch the inner door between an open and closed position, wherein the status of the inner door is displayed;
displaying the status of the outer door of the entry exit module and the input comprises a second input cause a motor coupled with the outer door to switch the outer door between an open and closed position;
displaying a status of tracks in the entry exit module;
displaying whether a vehicle is present in the entry exit area, and the input comprises a third input further causes a vehicle to be moved out of the entry exit module;
displaying whether the entry exit module is operating entry mode or exit mode, the input comprises a fourth input causes the entry exit station to switch between entry mode and exit mode;
displaying a height of a vehicle and an orientation of a vehicle when a vehicle is present in the entry exit module; and
displaying the overall maximum length, maximum width, maximum weight and maximum height of the vehicle.

16. The method of claim 14, wherein the selected diagnostic screen is an entry level carrier module, Carrier module with Turn Table (CM-TT), diagnostic screen that corresponds to the entry level carrier module, the method further comprising:
displaying a graphical representation of a location of a vertical lift carrier and an entry exit station;
displaying a visual indication of a status of a cable reel;
receiving a first input for switching the cable reel on and off;
receiving a second input operable to cause the entry level carrier to move and locate a barcode;
displaying data obtained from the barcode that provides data on aisle location and floor number;
receiving a third input operable to move the entry level carrier module a predefined distance;
displaying a visual indication of whether a rack entry module is present;
displaying a visual representation of coordinates for the entry level carrier;
receiving a fourth input to manually update the position of the entry level carrier;
displaying a visual representation of the entry level carrier along an axis;
receiving a fifth input operable to cause the carrier to move along the axis a designated distance;
displaying location data representative of an aisle and row of the entry level carrier;
receiving a sixth input operable to cause the entry level carrier to a designated aisle;
receiving a seventh input operable to cause the entry level carrier to get a pallet;
receiving an eighth input operable to cause the entry level carrier to store a pallet;
displaying a visual indication of an orientation of a turntable associated with the entry level carrier;
receiving a ninth input operable to cause the turntable to rotate a predefined distance in a first direction;
receiving a tenth input operable to cause the turntable to rotate a predefined distance in a second direction;
receiving an eleventh input operable to cause the turntable to move to a predefined position;
receiving a twelfth input operable to clear an error code from the display;
receiving a thirteenth input operable to cause the display to display a rack entry module diagnostic screen; and
receiving a reset strobe input that is operable to reset a plurality of strobes, and clears a last position search.

17. The method of claim 14, wherein the selected diagnostic screen is a rack entry module diagnostic screen that corresponds to the rack entry module, the method further comprising:
displaying in a first area of the diagnostic screen status data for the rack entry module, the status data comprises data representative of a position of the rack entry module, whether a pallet is present on the rack entry module, and data representative whether an error was detected;
receiving a first input operable to update a position of the rack entry module;
receiving a second input operable to cause the rack entry module to a specified distance;
receiving a third input operable to clear an error message from the display;
receiving a fourth input operable to cause the rack entry module to abort a move;
receiving a fifth input operable to cause the rack entry module to abort a move of a carrier module associated with the rack entry module;
displaying in a second area of the diagnostic screen a graphical view of a real-time position of the rack entry module within the robotic parking garage;
displaying in a third area of the diagnostic screen a position of a first and second corners of a lift of a lift of the rack entry module;
receiving a sixth input operable to release a lockout;
displaying in a fourth area of the diagnostic screen a position of third and fourth corners of the lifts of the rack entry module;
receiving a seventh input operable to cause a lift to move to a specified position in a first direction;
receiving an eighth input operable to cause the lift to move to a specified position in a second direction;
displaying in a fifth area of the diagnostic screen a total time for moving a vehicle selected form a group consisting of getting and putting the vehicle or pallet from a device adjacent from the rack entry module from a group consisting of a slot and a vertical lift carrier;
displaying in a sixth area are the diagnostic screen a visual indication of a status of a brake in a lift motor;
receiving a ninth input that is operable to retrieve a carrier module diagnostic screen for the carrier module;
receiving a tenth input that is operable to cause a search for a strobe on a first side of the rack entry module;
receiving an eleventh input that is operable to cause a search for a strobe on a second side of the rack entry module;
receiving a first homing input that is operable to cause the rack entry module to move to a first position on the carrier module;
receiving a second homing input that is operable to cause the rack entry module to move to a second position on the carrier module;
receiving a first jog input that is operable to cause the rack entry module to move a predefined distance in a first direction;
receiving a second jog input that is operable to cause the rack entry module to move a predefined distance in a second direction;
operating a first switch input to cause a strobe light at a home position to selectively operate in one of a group consisting of an on and off position;
operating a second switch input that is operable to cause a strobe light associated with a row to selectively operate in one of a group consisting of an on and off position;
operating a mode switch that is operable to selectively operate the rack entry module in a mode selected from a manual, a first automatic mode that employs operator inputs, and a second automatic mode that employs computer inputs; and
receiving a reset strobe input that is operable to reset a plurality of strobes, and clears a last position search.

18. The method of claim 14, wherein the selected diagnostic screen is an upper-level horizontal carrier diagnostic screen that corresponds to the upper-level horizontal carrier module, the method further comprising:
displaying on the diagnostic screen a visual representation of a first aisle and a second aisle adjacent to the upper-level horizontal carrier module;
displaying on the diagnostic screen a visual representation of a location of a vertical lift carrier located in an aisle selected from a group consisting of the first aisle and the second aisle;
displaying on the diagnostic screen a visual representation of a location of a pallet vertical lift located in an aisle selected from a group consisting of the first aisle and the second aisle;
displaying on the diagnostic screen a visual representation of a location of the upper-level horizontal carrier module with respect to the first aisle and the second aisle;
displaying on the diagnostic screen a visual representation of the upper-level horizontal carrier module's position;
displaying on the diagnostic screen a visual representation of whether an error condition was detected;
displaying on the diagnostic screen a graphical representation of a cable reel and a status of the cable reel;
receiving a bar code read input operable to cause a bar code scanner associated with the upper-level horizontal carrier modules to read a bar code and a visual representation of an aisle and floor of a barcode read by the bar code scanner;
displaying on the diagnostic screen a visual representation of a position of a rack entry module;
displaying on the diagnostic screen at a move commands section data representative of the aisle and the floor where the upper level horizontal carrier modules is located, receiving a first move command input that is operable to cause the upper level horizontal carrier modules to move to a particular aisle, receiving a second move command input to cause the upper level horizontal carrier module to get a pallet, receiving a third move command input that is operable to cause the upper level horizontal carrier module remove a pallet off of the upper level horizontal carrier module;
receiving a clear error input that enables an operator to clear an error detected for the upper-level horizontal carrier module;
receiving a reset strobe input operable to cause a reset a strobe light and clears a last position search;
receiving a rack entry module abort input that is operable to cause upper-level horizontal carrier module to abort a rack entry module move;
receiving an upper-level horizontal carrier module abort input operable to cause the upper level horizontal carrier module to abort a movement;
receiving a change diagnostic screen input that is operable to cause the selected diagnostic screen to change to a remote entry module diagnostic screen;
receiving at least one mode input operable to select an operating mode of the upper-level horizontal carrier module; and
receiving a reset strobe input that is operable to reset a plurality of strobes, and clears a last position search.

19. The method of claim 14, wherein the selected diagnostic screen comprises a Vertical lift conveyor Drive diagnostic screen a vertical lift conveyor deck diagnostic screen, the method further comprising:
displaying a visual representation of a location of the vertical lift conveyor module and when an error is detected, an error code corresponding to the detected error;
receiving a barcode read input operable to cause a barcode reader on the Vertical lift conveyor Deck to read a barcode and present a visual representation of machine number and a floor read by the barcode reader;
displaying a graphical representation of the status of brake on a first motor and a second motor;
receiving a move to floor input operable to obtain data representative of a specified floor and is operable to cause the vertical lift carrier module to move to the specified floor;
receiving a pickup vertical lift conveyor deck input that is operable to cause the deck to move into an up position;
receiving a settle down vertical lift conveyor deck input that is operable to cause the deck to move into a down position;
receiving data representative of a desired distance to move the vertical lift conveyor deck, and cause the deck to move to the desired distance;
receiving an abort input operable to cause the vertical lift conveyor drive module to stop all movements of the vertical lift conveyor deck module;
receiving a Vertical lift conveyor Drive gear out input that causes the first motor and second motor to move individually without synchronization;
receiving a Vertical lift conveyor—Drive a gear-in input that causes the first motor and second motor to operate in synchronization;
receiving a bypass over/under travel input operable to allow the vertical lift conveyor deck to move past an over limit position or an under-limit position;
receiving a bypass overhang limit that is operable to allow the vertical lift conveyor deck to move past an overhang limit;
receiving a jog up input operable to cause the vertical lift conveyor deck to move up a predefined jog speed;
receiving a jog down input operable to cause the vertical lift conveyor deck to move down a predefined jog speed;
receiving a deck locks extend input operable to cause the vertical lift conveyor deck's locks to extend;
receiving a deck locks retract input operable to cause the vertical lift conveyor deck's locks to retract;
receiving a visual representation of a vertical lift conveyor deck error code;
receiving a clear Vertical lift conveyor Drive clears a lift error detected on the drive;
receiving a vertical lift conveyor deck clear error input operable to clear a detected deck error;
receiving a PMM error input operable to clear an error received from a servo control module associated with the Vertical lift conveyor Drive receiving a first deck lock extend input operable to cause a pair of first deck locks to extend;
receiving a second deck locks extend input operable to cause a pair of second deck locks to extend;
receiving a first deck locks retract input operable to cause the pair of first deck locks to retract; and
receiving a second deck locks retract input operable to cause a pair of second deck locks to retract.

20. The method of claim 14, wherein the selected diagnostic screen is a pallet shuttle diagnostic screen that corresponds to the pallet shuttle, the method further comprising:
providing a visual representation of an aisle, which provides a location of an entry exit station, a pallet stacker, and a pallet vehicle lift, and whether a pallet is present in an entry exit station;
providing a visual representation of a real time position of the Pallet Shuttles;
providing a visual representation of a status of the pallet shuttle that comprises position data and data representative of a detected error, and a code associated with the detected error;
receiving a reset strobe input that is operable to reset a plurality of strobes, and clears a last position search;
receiving an abort pallet shuttle input that aborts a pallet shuttle lift move;
receiving a release lockout input operable to cause a Rack Entry Module to release a lockout of the pallet shuttle;
receiving a clear error input operable to clear an error for the pallet shuttle;
receiving an abort input operable that causes the pallet shuttle to stop;
receiving a first locate slot input operable to cause the pallet shuttle to move in a first direction and locate a barcode;
receiving a second barcode slot input operable to cause the pallet shuttle to move in a second direction to locate a barcode;
providing a visual representation of whether a strobe is being detected in a first direction;
providing a visual representation of whether a strobe is being detected in a second direction;
receiving a first pallet shuttle jog input operable to cause the pallet shuttle to move a predefined distance in a first direction;
receiving a second pallet shuttle jog input operable to cause the pallet shuttle to move a predefined distance in a second direction;
receiving a position set update input operable to cause a position of the pallet shuttle to be updated;
receiving a move distance input operable to move the pallet shuttle to a selected position;
receiving an update position input operable to cause the position set of the pallet shuttle;
receiving a move distance by counts input operable to receive a selected distance and a go to position input operable to move the pallet shuttle the selected distance;
receiving a lift jog up input operable to cause a lift on the pallet shuttle to move a predefined distance in a first direction;
receiving a lift full up down input operable to cause the lift on the pallet shuttle to move to a full up and full down position respectively;
receiving an add/remove pallet input operable to cause a pallet shuttle lift to go to a position where a pallet is to be one of a group consisting of added to and removed from a pallet stacker;
providing a visual representation of an actual lift position and an error code for the lift;
providing a visual representation indicating whether a pallet is present;
providing a visual representation of a first lift position;
providing a visual representation of a second lift position; and
providing a visual representation of a number of times the lift has been raised and lowered.
